(19) United States
(12) Patent Application Publication
(10) Pub. No.: US 2016/0079829 A1
(43) Pub. Date: Mar. 17, 2016

(54) ACCELERATED FLUID MACHINE

(71) Applicants: Eudes VERA, London (GB); Eudes VERA, Barcelona (VE)

(72) Inventor: Eudes VERA, Barcelona (VE)

(21) Appl. No.: 14/890,942

(22) PCT Filed: Apr. 8, 2013
(86) PCT No.: PCT/GB2013/050901

§ 371 Date: Nov. 13, 2015

(51) Int. Cl. H02K 7/18; F01D 9/04; F01D 15/10; F01D 25/24; F03B 11/02; F03D 1/04; F03D 9/00; F03B 3/12; F03B 3/18; F01D 5/02; F03D 1/06

(52) U.S. Cl. CPC H02K 7/1823; F01D 5/02; F01D 9/041; F01D 15/10; F01D 25/24; F03D 1/06; F03D 1/04; F03D 9/002; F03B 3/126; F03B 3/18; F03B 11/02; F05D 2220/30; F05D 2240/128; F05D 2260/40; Y10S 415/916; F03B 17/005

(57) ABSTRACT

The Accelerated Fluid Machine is an apparatus capable of generating inexpensively renewable and clean mechanical and/or electrical energy for powering partly or totally a vehicle, or a location (home, building, factory, etc.). Therefore it is an economical and effective way to reduce nowadays global warming and high energy costs. Its main components are a fluid-acceleration chamber and exhaust, and one or more fans placed inside it. It is an aerodynamic device whose operation is based upon the same physical principle of airplane flight. The generated energy comes from a fluid flow that can be created by one or more fans or captured from the environment into the chamber where it is accelerated. The machine produces no pollution, and requires no fuel at all as it is driven entirely by the fluid (typically air or water). It can be stationary, or mobile if carried by a vehicle.

### TECHNICAL FIELD

This patent application is submitted for the Accelerated Fluid Machine (AFM or AF machine), an apparatus capable of operating as an economical and efficient energy machine driven by a fluid that has been previously accelerated. The AF machine extracts part of the internal or thermal energy carried by the fluid, and converts it into either mechanical or electrical energy. Typically the fluid that drives the machine can be air, wind or water in whose case the machine can be called an Accelerated Airflow Machine (AAM), an Accelerated Wind Turbine (AWT), or an Accelerated Water Machine (AWM), respectively. The Accelerated Fluid Machine in any of its varieties requires no fuel and produces no contamination at all.

### BACKGROUND ART

Given present day high energy costs and alarming global warming stemming mainly from the burning of fossil fuels such as carbon and oil, methods and techniques for generating clean, and renewable energy have become urgent for the preservation of the planet and for improving effectively the quality of life of human beings. The AF machine will play a significant role to achieve the above mentioned goals.

It is surprising that despite the huge energy reservoirs contained in the atmosphere and in rivers, streams, lakes, and submarine currents all over the world, only a tiny proportion of it is extracted by present day energy devices and at very high costs. The AF machines have the capabilities of exploiting these reservoirs in a very efficient and economical way that surely will cause a definitive change of the world energy paradigm.

Nowadays wind turbine for generating powers in excess of 1 MW have very large dimensions, heights and weights as well as being very expensive to build and very damaging to flying fauna and the landscape. Other disadvantages of these machines are the difficulty to carry them from one place to another and their very low efficiency which is constrained by Betz's limit.

Accelerated Fluid Machines on the other hand can generate similar powers than conventional wind turbines but at a small fraction of the cost of the latter and with a great reduction in size, height, and weight, and they can be portable devices. Additionally, AF machines can be portable devices, and achieve efficiencies much higher than Betz's limit and as a bonus cause no harm to flying fauna.

Another interesting feature of the AF machine is that due to its portability feature the electrical or mechanical energy can be generated locally in the place where is needed. This surely will bring about a significant change in the world energy paradigm as power grids, long transmission and distribution lines will no longer be required as electricity can be generated by AF machines locally in every building, factory or home where is needed.

Taking into account that any moving land, sea or air vehicle is surrounded by an energy space, AF machines when installed in such vehicles can harvest considerable energy from the surrounding atmosphere or water when they are placed in direct contact with the environment.

### DISCLOSURE OF THE INVENTION

Two fundamental physical principles are exploited in the design and operation of the AF machine, namely, the fluid velocity multiplication that takes place within a fluid convergent nozzle, and the enormous mechanical power that can be developed by the lift force on a properly designed fan blade or streamlined turbine airfoil.

A fluid flowing past the surface of an airfoil-shaped body or fan blade, placed at a suitable attack angle α, exerts a surface force on it (FIG. 1). The lift force, L, is the component of this force that is perpendicular to the oncoming flow direction. It contrasts with the drag force D, which is the component of the surface force parallel to the flow direction. The same forces appear in the case the fluid is stationary and the blade moves through it with a velocity V_{φ}, as takes place on an airplane wing.

For a fluid flowing in a pipe or a duct and impacting a set of (one or more) rotary blades that has been suitable placed within the fluid passage, and facing the flow, the Reynolds Number is defined as Re=ρcV_{φ}/μ, where ρ and μ are the fluid density and the fluid viscosity, respectively; V_{φ} is the velocity of the free-stream fluid flow, and c is the chord of the blade. If the Reynolds Number is greater than about 500,000, and turbulence is somehow kept to a minimum, then the ratio L/D becomes large, usually much greater than 1. In this case, if forces acting on the blades are allowed to perform a mechanical work, it is well known that the mechanical power developed on the rotary shaft attached to the blades is proportional to V_{φ}³. Therefore, the useful power generated can be increased simply by augmenting the fluid velocity V_{φ} before the fluid flow strikes the blades. This is done by making the fluid flow pass first by an accelerating chamber or convergent nozzle

The following references are used in this patent application:
Reference 1: Fundamentals of Fluid Mechanics, Sixth Edition SI Version, By: B. R. Munson, D. F. Young, T. H. Okiishi, and W. W. Huebsch. Publisher: John Wiley & Sons, 2010
Reference 2: United States Patent Application Publication, Use of Air Internal Energy and Devices, by Hirshberg, I, Pub. No.: US 2008/0061559 A1, Pub. Date: Mar. 13, 2008
Reference 3: United States Patent Application Publication, Thermal Airfoil Turbine, by Luis Indefonso Solórzano, Pub. No.: 20110097209 A1, Pub. Date: Apr. 28, 2011
Reference 4: Wind Turbine Blade Analysis using the Blade Element Momentum Method, Version 1.1, by Grant Ingram, Creative Commons Attribution-ShareAlike 3.0 Unported License, Oct. 18, 2011

Henceforth some fundamental assumptions are made: First, In order to apply safely Bernoulli Equation, the fluid is assumed to be laminar, incompressible and inviscid (Page 99 of Ref.1). Liquid fluids will be considered as incompressible. In the case of a gas fluid, like air or wind, it will be considered as incompressible if the fluid flow speed striking the turbine or fan blades is kept below 0.3 Mach, i.e., below 102 m/s, for air or wind. Fluid viscosity is assumed to be very small to ensure an inviscid fluid (Page 94 of Ref.1). Second, Reynolds Number for the turbine blades is not less than 500,000. Third, Internal surfaces in contact with the fluid inside the machine are very well polished, so, apart from the fluid entrance and the fluid exhaust, the machine has no fluid leakage.

Convergent and Divergent Nozzles These are important components of an accelerated fluid machine. FIG. 2 shows schematically several forms of a fluid-acceleration chamber (FAC or FA chamber), and its constituent parts. We shall also refer to it as a convergent nozzle as opposed to a divergent nozzle that can be used in the AF machines as a fluid exhaust. A divergent nozzle, shown, schematically in FIG. 3, is just a convergent nozzle that has been turned around by 180° so that the convergent nozzle fluid entrance becomes the divergent nozzle fluid exit and vice versa.

The cross-sectional area as seen by the fluid flow at the entrance of the convergent nozzle is given by

A_{φ1}=(π/4)D₁² (1)

The cross-sectional area as seen by the fluid flow at the exit of the convergent nozzle is given by

A_{φ2}=(π/4)(D+d)(D−d) (2)

It can be readily shown by applying the continuity equation that if the fluid velocities at the entrance of the FAC and at the exit of the FAC are V_{φ1} and V_{φ2}, respectively, and the cross-sectional areas at the entrance of the FAC and at the exit of the FAC are A_{φ1} and A_{φ2}, respectively, then

V_{φ2}=(A_{φ1}/A_{φ2})V_{φ1} (3)

Let us now define the parameter Fluid Velocity Multiplier K as

k_{f}=(A_{φ1}/A_{φ2})=V_{φ2}/V_{φ1} (4)

Fluid velocity V_{φ2} can be made greater than V_{φ1} simply by making the multiplying factor k_{f} greater than 1, i.e., by making A_{φ1}>A_{φ2}.

If geometric parameters D and d are fixed so it will be the FAC exit cross-sectional area A_{φ2}, according to Eq. (2). Hence the fluid velocity multiplier k_{f} can be increased by making the input cross-sectional area A_{φ1} bigger than the FAC exit area A_{φ2}. Since

A_{φ1}=(π/4)D₁² (5)

A_{φ1} can be increased by making input diameter D₁ bigger. For this purpose we define the latter as

D₁=D+kd (6)

Where k is an integer. (k=0, 1, 2, 3 . . . ). The value k=0 corresponds to the case when the AF machine uses no convergent nozzle.

Then, by substituting Eq. (6) in Eq. (5) we obtain

A_{φ1}=(π/4)(D+kd)² (7)

By substituting Eq. (7) and Eq. (2) in Eq. (4), we obtain

k_{f}=(D+kd)²/(D+d)(D−d) (8)

The fluid-acceleration chamber can have many possible shapes, but to simplify its manufacturing and to minimize turbulence the shape shown in FIG. 2(e) is to be preferred. It consists basically of a cone with a circular base of diameter d, and length lₙ placed concentrically inside a larger truncated cone with circular entrance of diameter D₁, and annular outlet formed by minor circle of diameter d, and surrounding circle of diameter D. To ensure a convergent nozzle the inequality D₁>D>d>0 has to be fulfilled. It is possible to use a truncated cone with a cross-sectional shape other than a circular one, but the latter is preferred for the reasons pointed out above. To keep turbulence losses to a minimum, the slope angle β formed by the cone walls and the cone axis, as is shown in FIG. 2 (f), must be kept low, typically not greater than 10°.

The length of the convergent nozzle can be can be calculated from the formula

lₙ=kd/(2 tan β) (9)

As is shown in pages 3-7 of Ref. 2, the increase in wind velocity caused by a convergent nozzle brings about a reduction of a few degrees in the airflow temperature and this fact can be exploited to extract water out of the atmosphere as a useful by-product of the convergent nozzle.

As to the internal concentric truncated cones, shown in nozzles in FIG. 2 (c) and FIG. 2(e), these are simply used as guide vanes to split the total flow entering the nozzle in several convergent sub flows for the purpose of making the fluid streamlines as straight as possible and to minimize intermixing and turbulence. The guide vanes are thin rigid elements that can be made of materials like metal, plastic, carbon fiber, glass fiber, etc. The larger the number of these sub nozzles the less the turbulence, but the greater becomes the drag force and the weight of the FA chamber. Hence a compromise has to be set up. FIG. 4 shows the 8 truncated cones that make up the fluid-acceleration chamber shown in FIG. 2 (c) and FIG. 2(e). The geometrical parameters (diameters and lengths of the truncated cones have to grow progressively from TC1 up to TC8, while keeping constant the slope angle β. For example the cone lengths have to fulfill the following relationship

lₙ>lₙ₇>lₙ₆>lₙ₅>lₙ₄>lₙ₃>lₙ₂>lₙ₁>0

FIG. 5 shows the convergent flow sub-path formed by combining truncated cones TC6 and TC7 of FIG. 4. It is possible to further subdivide this sub-path by splitting it radially in two or more smaller sub-paths, but this is not done here so to keep the figures simple.

In FIG. 3, several forms of a divergent nozzle and its constituent parts are shown. The divergent nozzle is another important component of an AF machine, and it is used as the machine fluid exhaust. It is identical in shape to the converging nozzle previously described except that the fluid entering through its inlet with a speed V_{φ3} is decelerated and comes out with a much lower speed V_{φ4}, and the relationship between V_{φ3} and V_{φ4} is given by

V_{φ4}=V_{φ3}/k_{f} (10)

On the other hand, the divergent nozzle input and output cross-sectional areas, A_{φ3} and A_{φ4}, respectively, are also related by

A_{φ3}=(A_{φ4}/k_{f}) (11)

Where k_{f} is given by Eq. (8)

k_{f}=(D+kd)²/(D+d)(D−d) (8)

And k is an integer. (k=0, 1, 2, 3 . . . ). The value k=0 corresponds to the case when the AF machine uses no divergent nozzle.

The purpose of the divergent nozzle is to reduce the fluid speed V_{φ3} at its entrance as much as possible to minimize fluid power loss at its exit. As in the case of the convergent nozzle, the slope angle β of the divergent nozzle is taken to be not greater than 10° to minimize turbulence. In the case of a symmetrical AF machine, defined as one having convergent and divergent nozzles of identical shape and size, the divergent length lₙ can be calculated also from Eq. (9).

FIG. 6(a) shows schematically a longitudinal view of an open chamber AF machine containing two fluid turbines. Alternatively, instead of the fluid turbines, two electric fans can be used.

From now on, by fluid turbine we mean one similar to the Thermal Airfoil Turbine, as described in Reference 3. As an example of this turbine, FIG. 7 shows an schematic diagram of a fluid turbine consisting of eight airfoils placed on the periphery of an internal cylinder or hub of diameter d and surrounded by an external cylinder of diameter D, (D>d>0), as is shown in the frontal view in FIG. 7(a). The other dimension of the thermal airfoil turbine is its length lₜ, shown in the side view in FIG. 7(b), which also shows the dimensions of the airfoils, namely the chord c, the span s, and the thickness t. As to the maximum number of airfoils that can be placed in the turbine, the only restriction is that airfoils do not interact among them and that they occupy the annular fluid passage of dimensions (πd)(D−d)/2)(lₜ).

As shown in FIG. 6, the basic components of an accelerated fluid machine are: First: The Fluid Acceleration Chamber (FAC or FA chamber), which is the component in the form of a convergent nozzle where the fluid is accelerated. There are 4 possible varieties of the FA chamber, and they are shown in FIG. 2. FIG. 2(b) depicts the simplest FA chamber. It consists simply of a truncated cone having a large circular entrance with diameter D₁, and a smaller annular outlet defined by a large circle of diameter D and a smaller circle of diameter d. Dimensions D and d correspond to the large and the small diameter of the Venturi-like throat section that follows the FA chamber. Another possible FAC shape is shown in FIG. 2 (c), which is similar to the one shown in FIG. 2(a), but with the addition of several concentric vanes in the form of truncated cones. FIG. 2(f) shows another possible FAC shape, which is similar to the one shown in FIG. 2(b), but with the addition of a central cone, like the one shown in FIG. 2(d). Finally, FIG. 2(e) shows the FA chamber which offers the best performance, in terms of laminarity of the fluid. It is a combination of FA chambers shown in FIGS. 2(c) and 2(f), and it is the one appearing in FIG. 6. Second: The Venturi-like throat, or just the throat for short, which is the straight and narrowest section of the AF machine, where the fluid speed V_{φ} is a maximum and constant. It contains one or more aerodynamic fluid turbines similar to the thermal airfoil turbine. An aerodynamic fluid turbine is formed by a set of rotary streamlined airfoils or blades placed and attached around the periphery of an internal central circular cylinder of diameter d, and surrounded by another external circular cylinder of diameter D (D>d>0), as is shown in FIG. 7. The center of the internal cylinder is the hub, with a diameter dₛ<d, length lₜ, and houses the turbine shaft, as is shown in FIG. 7. Optionally the throat can additionally contain one or more Flow Straighteners, which are simply two concentric cylinders of diameters D and d, (D>d>0), as shown in FIG. 8(e), containing one or more guide vanes in the form of concentric cylinders placed in between cylinders of diameters D and d. FIGS. 8(b) and 8(c) show schematically vanes 3 and 2, with diameters Dᵥ₃ and Dᵥ₂, respectively, and FIG. 8(a) shows the fluid annular sub-path formed by vanes 2 and 3 combined. The diameters of the vanes satisfy the following inequality: d<Dᵥ₁<Dᵥ₂<Dᵥ₃<Dᵥ₄<D. The primary function of the flow straighteners is to increase the laminarity of the flow before it strikes turbine blades. There can be several cylindrical vanes in a flow straightener but again a compromise has to be set up between the number of vanes and its weight and the increase in drag force they bring about. Third: The Exhaust Chamber, which is just the result of rotating a convergent nozzle like the ones shown in FIG. 2, by a 180° angle, i.e., it is just a divergent nozzle, and if the AF machine is symmetrical, it has similar geometric dimensions, but it could have its larger diameter Dₒ different from Dᵢ, and its length lₒ can be also different from lₙ. The exhaust chamber acts as the fluid outlet to the environment. It is also possible for the AF machine to contain just the Venturi-like throat and no nozzles, as the example shown in FIG. 9, but this arrangement is less efficient since it operates at a less fluid velocity due to the lack of the converging nozzle. And the lack of a divergent nozzle exhaust gives rises to a lot of turbulence and losses at the fluid outlet. Also it is possible to have only fluid turbines (or electric fans for that matter) and no fluid straightening separators in the throat section as is shown in FIG. 10 for an AF machine containing just 4 turbines in its throat, but this arrangement is prone to operate with a less laminar fluid than the AF machine shown in FIG. 6.

The purpose of the exhaust chamber is to gradually reduce the fluid velocity from its value V_{φ} in the throat down to the value V_{φo} just outside the exhaust chamber and thus to decrease the power of the exhaust fluid as much as possible. (See FIG. 3).

The total length of the AF machines shown in FIGS. 6 and 10 is

L=2lₙ+lₜₕ (12)

Where lₜₕ is the throat length equal to 4lₜ for both machines. In general,

lₜₕ=Nlₜ (13)

Where N is the total number of spaces of length lₜ that can be accommodated in the throat length.

The total width of the AF machine is

W=D+kd (14)

An important feature of the AF machine is the fact that the fluid turbines are placed in a position perpendicular to the direction of the fluid flow, with their blades all facing the oncoming flow. As a result, all the turbine blades are impacted simultaneously by the fluid flow.

### Varieties of AF Machines

In general, AF machines can be classified as open chamber and closed chamber AF machines. In open chamber variety the operating fluid can enter and leave the machine, as shown in FIGS. (6) and (10). On the other hand, closed chamber AF machines to be explained later are hermetically closed to the external fluids.

There are two ways of having the fluid flow within the AF machine: It can be artificially generated at the entrance of the FA chamber by one fan or within the throat by one or more fans. In this case the AF machine can be open or closed.

Alternatively, if the fluid is external to the machine, it can be captured by the FA chamber by allowing it to enter the chamber. Hence, for an open chamber AF machine, the FA chamber or converging nozzle has the following functions: 1. To capture or generate the fluid flow. 2. To increase the fluid velocity, and 3. To conduct the flow toward the Venturi-like throat. In the throat the flow will impinge on one or more sets of turbine foils or fan blades which in accordance to aero dynamical laws will extract part of the flow thermal energy. Thus the AF machine can generate more mechanical energy than the input flow kinetical energy, as shown in the calculation results of Table I.

The open chamber AF machine can be stationary and the external fluid flow can be a wind flow, a tidal flow, a submarine current, a stream, or a river current. Alternatively it can be mobile, and in contact with the external fluid, i.e., it can be carried by a vehicle moving at a velocity V_{φ1} through the surrounding fluid. In this case the FA chamber of the AF machine can be used to capture the fluid and to increase its velocity up to a certain value V_{φ2}. In the event the AF machine used is hermetically closed or placed within a fixed location like a house room, the fluid flow has to be created artificially by one fan placed within the FA chamber or one or more fans placed within the throat. In the latter case, the AF machine can be open or closed.

As shown in FIGS. 6. 9 and 10, the Venturi-like throat is formed by one or more sections each consisting of two concentric cylinders of length lₜ and different diameter, the external one with diameter D, and the internal one, also called hub, with diameter d. Diameters must satisfy the inequality (0<d<D). In general, the external cylinder will be stationary, and the internal one can be stationary or rotary. There can be two types of sections, namely, flow straighteners and fluid turbines (instead of fluid turbines, fans can be used). Flow straighteners contain just a hub and one or more fluid director vanes, as shown in FIG. 8. As is shown in FIG. 7, fluid turbines consist of an internal cylinder or hub of diameter d, and a number of blades or foils placed around and over the periphery of the latter. The blades can rotate around the hub axis. Usually the turbines or fans will be placed in such a way that the diameter of the rotor will be the same as d, and the width or span s of the fan blades occupy totally or a large part of the empty space between the internal and external cylinders, as is shown in FIG. 7.

The Venturi-like throat houses the turbines or fans which are placed coaxially inside it. The fan shafts can be interconnected, or not. The purpose of the fans is to generate mechanical and/or electrical energy out of an incoming fluid that has been previously accelerated in a convergent nozzle. Usually the turbine airfoils or the fan blades are placed forming a setting angle γ with the flow direction of about 45°, as can be seen in FIG. 7(b) and FIG. 11(b) for maximum L/D ratio, but making sure that stall does not take place. On the other hand, some of the fans can be used to add kinetic energy to the fluid in whose case they will not work as fluid turbines but rather as pumps (motor fans).

A particular variety of the acceleration fluid machine, the symmetrical AF machine, is shown in FIGS. 6 and 10. It consists of the Venturi-like throat and identical convergent and divergent nozzles, both having the same length (lₙ), the same cone diameter (d), the same funnel internal diameter (D), and the same funnel external diameter (input diameter Dᵢ=output diameter Dₒ). See also FIGS. 2 and 3. Unless otherwise specified in the rest of this document we will assume that Dᵢ=Dₒ=D+k d, where k=0, 1, 2, or a greater integer. The value k=0 corresponds to the case where the AF machine uses no nozzle.

### Mechanical Power Calculations

Consider a fluid turbine (which can also be an electric fan, with driving motor M, like the one shown in FIG. 12), placed in the Venturi-like throat of an AF machine, as the one shown schematically in FIG. 11(a). If the absolute velocity of the fluid entering the fluid accelerating nozzle of this AF machine is V_{φ1}, then the absolute fluid velocities in the throat of the AF machine, V_{φ2} and V_{φ3} are equal and given by

V_{φ2}=V_{φ3}=k_{f}V_{φ1} (15)

Where the fluid velocity multiplier k_{f} is given by Eq. (8). It is worth noticing than in a conventional wind turbine where no throat is present normally V_{φ3}<V_{φ2} because the turbine blades decelerate the incoming wind speed V_{φ2}. (Reference 4, page 6). But in an AF machine due to the presence of the throat velocities V_{φ3} and V_{φ2} are the same if an inviscid fluid is assumed.

FIG. 11(b) shows the forces dL (Lift force) and dD (Drag force) acting on a blade element of chord c and area cdr, located at a distance r from the turbine hub center. When fluid in the throat of velocity V_{φ2} strikes the plane of rotation perpendicularly, as shown in FIG. 11(a) and FIG. 11(b), turbine blade B sees the incoming fluid approaching with a relative velocity V_{φ} forming a flow angle φ with the plane of rotation. On the other hand, the blade B moves with a tangential force V_{B} related to velocities V_{φ} and V_{φ2} by

V_{φ2}=V_{φ}+V_{B} (16)

The angle formed by the apparent velocity V_{φ} and the blade chord c is the attack angle α, and the angle formed by the chord c and the plane of rotation is the setting angle γ. From FIG. 11(b) it can be seen that angles α, γ and φ are related by

φ=α+γ (17)

Henceforth we will assume the turbine blades have a constant setting angle γ, a constant thickness t, a constant chord c, and a constant span s. The latter is given by

s=(D−d)/2 (18)

From FIG. 11(b) it can be seen that velocities V_{φ2} and V_{φ} are related by

V_{φ}=V_{φ2}/sin φ (19)

If flow angle φ is less than 90°, it can be seen from Equations (19) and (15) that the following inequality is fulfilled for an AF machine

V_{φ}>V_{φ2}>V_{φ1} (20)

Forces dD and dL are given by (Reference 4, page 10)

dD=C_{D}ρV_{φ}²cdr/2 (21)

dL=C_{L}ρV_{φ}²cdr/2 (22)

Where C_{D}=Drag coefficient of blade; C_{L}=Lift coefficient of blade; ρ=Density of the accelerated fluid.

The torque on the blade element, dT, can be shown to be given by (Reference 4, p.11)

dT=ρV_{φ}²(C_{L} sin φ−C_{D} cos φ)crdr/2 (23)

This torque around the central axis of rotation causes the rotary movement of the blade element. Accordingly if the turbine has N_{b} blades, it can be readily shown that the average mechanical power developed by the turbine on its shaft is

P_{g}=N_{b}ωρV_{φ}²(C_{L} sin φ−C_{D} cos φ)c(D²−d²)/16 (24)

Where ω is the turbine rotational speed in radians per second which can be converted into n, revolutions per minute (RPM) by

ω=πn/30 (25)

By combining Eq. (24) and Eq. (25) we obtain

P_{g}=(π/480)ρ(C_{L} sin φ−C_{D} cos φ)N_{b}c(D²−d²)nV_{φ}² (26)

On the other hand, it can be readily shown that

n=15[NₚρN_{b}(D²−d²)c(C_{L} sin φ−C_{D} cos φ)/(πlₜ)]^{1/2}V_{φ} (27)

Where lₜ is the turbine's moment of inertia about its rotational axis, and Nₚ is the total (integer or fractional) number of periods the turbine rotates to reach constant speed n, when starting from n=0. Nₚ is a quantity that can be measured experimentally for each turbine.

By substituting Eq. (27) into Eq. (26) we obtain the important relationship

P_{g}=[πNₚ/(16lₜ)]^{1/2}[ρN_{b}C(D²−d²)(C_{L} sin φ−C_{D} cos φ)]^{3/2}V_{φ}³ (28)

Equation (28) clearly indicates that in order to maximize the mechanical power generated by a single turbine it is more effective to increase velocity V_{φ} (By increasing fluid velocity V_{φ2} in the Venturi-like throat) than increasing factors (C_{L} sin φ−C_{D} cos φ), N_{b}, c and or (D²−d²). This is the approach we will use to design our AF machines and for this purpose we use the FA chamber to increase the incoming fluid velocity V_{φ1} so that the fluid reaches the Venturi-like throat with maximum speed V_{φ2}.

The total mechanical power generated can also be increased by augmenting the number of fluid turbines (or fans, for that matter). If Nₜ identical fluid turbines each with N_{b} blades are contained within the Venturi-like throat of an accelerated fluid machine, the total mechanical power generated by the Nₜ fluid turbines is:

P_{g}=(π/480)ρ(C_{L} sin φ−C_{D} cos φ)N_{b}Nₜc(D²−d²)nV_{φ}² (29)

Calculation of the Mechanical Power Gain for an AF Machine The input power of the fluid at the inlet of an AF machine is given by

P_{φi}=ρA₁V_{φ1}³/2 (30)

Where A₁ is the inlet cross-sectional area at the entrance of the FA chamber of diameter D+kd, as shown in FIG. 11(a), and given in general by

A₁=(π/4)(D+kd)² (31)

And the input fluid power can be expressed as

P=(πρ/8)(D+kd)²V_{φ1}³ (32)

But, by using Eq. (8),

(D+kd)²=(D+d)(D−d)k_{f} (33)

Then P_{φi} can be written as

P_{φi}=(πρ/8)(D+d)(D−d)k_{f}V_{φ1}³ (34)

By combining Eq. (19) with Eq. (15), we can express V_{φ} as

V_{φ}=k_{f}V_{φ1}/sin φ (35)

By substituting Eq. (35) in Eq. (26), we obtain

P_{g}=(π/480)ρ(C_{L} sin φ−C_{D} cos φ)N_{b}c(D²−d²)nk_{f}²V_{φ1}² sin² φ (36)

Which for Nₜ identical AF turbines can be written as

P_{g}=(π/480)ρ(C_{L} sin φ−C_{D} cos φ)N_{b}Nₜc(D²−d²)nk_{f}²V_{φ1}² sin² φ (37)

Let us now define the Mechanical Power Gain, or Efficiency, Gₚₘ, of the AF machine as

Gₚₘ=P_{g}/P_{φi} (38)

And by substituting Equations (34) and (37) into Eq. (38), we obtain for Nₜ turbines

Gₚₘ=[k_{f}/(60 sin² φ][ρ(C_{L} sin φ−C_{D} cos φ)N_{b}Nₜc](n/V_{φ1}) (39)

It can be seen from Equation (39) that the mechanical power gain Gₚₘ can be increased effectively by making the fluid velocity multiplier k_{f} as large as possible and this can be done simply by increasing the value of the integer k for the accelerating nozzle as can be seen from Eq. (8). Another less effective way consists of increasing the ratio (n/V_{φ1}), and/or increasing the value of ratio C_{L}/C_{D} and/or parameters c, N_{b}, and Nₜ.

Condition for Self Sustained Movement of the Fluid Turbines We state that the Accelerated Fluid Turbine System is operating in a self sustained movement regime if

Gₚₘ>1 (40)

According to Eq. (39) for an AF machine this inequality is equivalent to

[k_{f}/(60 sin² φ)][ρ(C_{L} sin φ−C_{D} cos φ)N_{b}Nₜc](n/V_{φ1})>1 (41)

Equation (41) is the condition for an AF machine to achieve a self sustained movement, and this is quite feasible to obtain as we show in the example below.

Numerical Results—Accelerated Wind Turbine For an Accelerated Wind Turbine (AWT), a particular type of an AF machine in which the operating fluid is the wind, with parameters: D=50 cm; d=30 cm; C_{D}=0.040163; C_{L}=0.46852; c=15 cm; s=10 cm; φ=45°; V_{φ1}=5 m/s; N_{b}=8 blades; Nₜ=4 turbines; n=900 rpm, and by applying Equations (8), (9), (15), (19), (32), (37) and (38), respectively, the results shown in Table I were obtained for k_{f}, lₙ, V_{φ2}, V_{φ}, P_{φi}, P_{g}, and Gₚₘ, both for k=1, and k=2.

TABLE I
Power calculation results for an Accelerated Wind Turbine

| | | | V_{φ1}, | V_{φ2}, | | | | |
|---|---|---|---|---|---|---|---|---|
| k | k_{f} | lₙ, m | m/s | m/s | V_{φ}, m/s | P_{φi}, W | P_{g}, W | Gₚₘ |
| 1 | 4 | 0.95 | 5 | 20 | 28.28 | 38.64 | 1,348.34 | 34.89 |
| 2 | 7.56 | 1.89 | 5 | 37.81 | 53.48 | 73.06 | 4,819.57 | 65.97 |

Thus for this particular AWT and wind speed it is possible to achieve a self sustained motion and generate a mechanical power of 4.820 kW for k=2.

### Use of Electric Fans and Building Blocks for Implementing AF Machines

Instead of aerodynamic fluid turbines, like the one shown in FIG. 7, whose blades or airfoils have been designed to achieve a C_{L}/C_{D} ratio as high as possible, accelerated fluid machines can also be implemented using conventional fans. FIG. 12 shows two possible types of axial fans that can be used for this purpose, namely, a mechanical fan (i.e., just a set of rotary blades, with no motor), like the one shown schematically in front view in FIG. 12(a); and an electrical fan (i.e., one composed of a rotary fan blade set plus a driving electric motor, M), as shown schematically in side view in FIG. 12(b). If the fan is mechanical, it can also be considered as a fluid turbine. Hence a mechanical fan can perform either as an air turbine, a water turbine or a wind turbine depending on whether the operating fluid is air, water or wind, respectively.

FIG. 13 shows the front and rear views of a typical commercially available axial electric fan that we can use instead of a fluid turbine. It includes a driving electric motor. The fan motor can be ac or dc, but the particular one shown in FIG. 13 is a brushless dc fan motor.

Henceforth, in order to differentiate the schematic diagram of an aerodynamic fluid turbine, like the one shown in FIG. 14(a), from that of a fan we will use for the latter the graphic representation shown in FIG. 14(e), which is the same representation of a fluid turbine but enclosed in a rectangular box, whose dimensions are chosen to be: (D+kd)×(D+kd)×(lₜ), as is shown in FIG. 14(c). These box dimensions are chosen to facilitate the construction of AF machines using electric fans as some of their building blocks. Similarly, fluid straighteners, as the one shown in FIG. 14(b), are also enclosed in a similar rectangular box, as shown in FIG. 14(d), for the purpose of using them as building blocks of AF machines implemented with electric fans.

Similarly, to facilitate modular construction of the AF machines, both the divergent and convergent nozzles, like the ones shown in FIGS. 15 (a) and 15(b), respectively, can be enclosed in rectangular boxes with dimensions (D+kd)×(D+kd)×(lₙ), like the one shown in FIG. 15(c). This results in the diverging and converging nozzle building blocks shown in FIGS. 15(d), and 15(e), respectively.

The front and back faces of both types of building boxes will normally be left open to allow the interconnection of modules, but the side faces will normally be closed to avoid fluid leakage. When interconnecting these building blocks together the fluid is allowed to flow from an open inlet nozzle of diameter D+kd to one or more electric fans placed coaxially in the throat only through the annular fluid passage bounded by external diameter D and internal diameter d, to finally exit the machine through an open outlet nozzle of diameter D+kd, if the latter is used, otherwise the outlet will be just one of the throat annular ends.

With the above mentioned building blocks we can build a large variety of fan AF machines. As an example, FIG. 16(a) shows an AF machine having 4 electric fans and 4 fluid straighteners. FIG. 16(b) shows another AF machine with 8 electric fans and no fluid straighteners. The throat length lₜₕ is just the sum of the lengths of the fans and fluid straighteners coaxially placed one behind the other in the throat. For easier manufacturing of the fan AF machine, the length of fans and fluid straighteners is chosen to be the same, lₜ. In FIG. 17 another AF machine implemented with 8 fans is shown. Then, if N is the total number of fluid straighteners and fans, then

lₜₕ=Nlₜ (42)

Assuming the fluid is incompressible, the maximum number of fans and fluid straighteners that can be placed coaxially within the throat is only limited by the shear stress appearing in internal walls and rotary blades due to the fluid viscosity μ that tend to close the flow passage as the number of fans is increased. Such an upper limit has to be established experimentally. If the fluid is a liquid, like water, it can be considered incompressible for all practical engineering purposes (Page 29 of Reference 1). If the fluid is a gas like air or wind it can be considered as incompressible if the flow velocity in the throat is kept below about 0.3 Mach (Page 128. of Reference 1). This is an important property of AF machines which normally cannot be achieved in conventional wind turbines, because they are generally designed to extract kinetic energy from the incoming wind, thus reducing its speed. On the contrary, in an accelerated fluid machine the incoming fluid is first accelerated in the FA chamber before striking turbine airfoils or fan blades placed in the Venturi-like throat.

There are two possible modes of operation for the electrical motor of an electrical fan. It can operate either as an electrical motor proper, or as an electric generator. In the first case a power supply is connected to the motor leads in order to create or reinforce the fluid flow. In the second case the motor leads are connected to an electric load and the rotary fan blades can spin as the result of a previously accelerated fluid impacting onto them. The accelerated fluid can be produced by one or more electric fans acting as starting motors or, it can stem from a natural source like the wind, airflow or a water flow made to enter into the fluid acceleration chamber. When the latter situation takes place we say that the fluid acceleration chamber has captured the external fluid flow. The fan blades mounted on the periphery of the fan rotor spin either when driven by the fan motor, or when impacted by the accelerated fluid flow. According to Faraday's Law, a voltage can be induced between the open leads of the fan motor that then performs as an electric generator capable of converting the rotational movement of the blades into an electrical current. Thus an electrical fan can operate either as a motor or as a generator. In the first case we will refer to the fan as a motor fan and in the second case either as a generator fan or a fluid (air, wind or water) turbine. The axes or shafts of the motor fan(s) and the generator fan(s) can be mechanically attached, or can be unattached but keeping always their co linearity.

Enclosed within the Venturi-like throat there must be at least one fan working as a generator fan, but it is possible for one or more of the electric fans to perform as motor fans. For example, in FIG. 17, all the eight fans can operate as generator fans, but there are other possibilities. For example, fans F₁, F₃, F₅ and F₇ can operate as motor fans, and fans F₂, F₄, F₆, and F₈ can operate as generator fans. Other motor-generator fan combinations are possible, but at any rate at least one of the fans has to operate as a generator fan in order to generate a useful power.

Both motor fans and generator fans can be physically identical or very similar, except perhaps for their internal electrical resistance. In fact, as is shown in Section Self Sustainable Fluid Electric Generator it is usually desirable for the total internal resistance of the generator fans to be much lower than the total internal resistance of the motor fans. In addition, the motor and the generator can be either dc or ac machines. Likewise, the blades of both motor fans and generator fans can be identical or very similar.

Accelerated Fluid Machines can be classified either as mechanical motors or as electric generators. In the first case there is no generation of electric energy, but just mechanical energy by mechanical fans or fluid turbines as their blades are rotated by a previously accelerated fluid. In the second case the mechanical energy generated is converted into electrical energy by one or more electric generator fans or by an ad hoc electric generator attached to the turbines shaft. Hence, depending on whether the intervening fluid is air, water or wind, there are 5 main types of AF machines, namely, the Air Motor (AM), the Water Motor (WM), the Air Electric Generator (AEG), the Water Electric Generator (WEG), and the Accelerated Wind Turbine (AWT). FIGS. 18, 19 and 20 show schematically examples of an Accelerated Wind Turbine, an Air Electric Generator, and a vertical Water Electric Generator, respectively. The AW turbine in the example shown in FIG. 18(a) is implemented with 4 thermal airfoil turbines, and the one shown in FIG. 18(b) is implemented with 4 electric fans. A novel feature of this wind turbine is that the wind can enter and exit in two possible directions, and generate power for each of the directions. The AE generator shown in FIG. 19(a) is implemented with 3 turbines plus a large electric fan F at the entrance of the converging nozzle whereas the one shown in FIG. 19(b) is implemented with 3 electric fans plus the big fan F at the entrance of the converging nozzle.

Notice that basically the same AF machine shown in FIG. 6 can perform as an AWT, an AEG or a WEG machine, depending on whether the operating fluid is wind, air or water, respectively, with some small change for the AEG, i.e., the addition of a large fan F at the entrance of the fluid acceleration chamber.

Any suitable material, like plastic, metal, etc., can be used to manufacture the fluid acceleration chamber and the exhaust chamber, provided it is light and resistant to degradation by the environment. The internal walls of the chambers have to be as smooth as possible to minimize power losses caused by the wall shear stress. In the remainder of this document we will assume that the internal walls of the chamber are perfectly polished and have no leaks. Regarding the thickness of the chamber walls, it is desirable for it to be as little as possible in order to keep machine weight as low as possible, but without compromising its sheltering properties.

Regarding the fan blades of the AF machine, they can be made out of plastic materials, resin, acrylic, or others. The two cylinders can be made with a light metal such as aluminum, or a light and hard plastic as well, etc., but weight must be minimized without compromising the material endurance and strength.

Important As to the possible values for the geometrical parameters D and d, the only requirement they must satisfy is: 0<d<D. As can be seen from Eq. (28), the useful power P_{g} generated by the fan or turbine blades is proportional both to (D²−d²)^{3/2} and to V_{φ}³. Hence the greater the values of these quantities the greater the generated power will be.

Note. Although it is possible to use inlet and outlet terminations with k=0, i.e., no nozzles, it is not recommended on the account of the larger turbulence of the exhaust terminations and the lack of the convergent nozzle to amplify the incoming fluid velocity.

According to Equations (4) and (10) it is readily apparent that the fluid acceleration chamber multiplies the incoming fluid velocity V_{φ1} by a factor k_{f}, whereas the exhaust chamber divides the fluid velocity V_{φ3} in the throat by the same factor if the accelerated fluid machine is symmetrical. Of course the greater the value of k the greater will be the size of the machine, according to Eq. (9), the parameter k_{f}, according to Eq. (8), and the generated power P_{g}, according to Eq. (37). On the other hand, the greater the value of k the smaller the output velocity V_{φ4}, according to Eq. (10), and the turbulence and power losses at the output.

The power P_{φ2} that is applied to the fan blades is

P_{φ2}=ρA_{φ2}V_{φ2}³/2 (43)

And the input power of the fluid at the inlet of the open chamber AF machine is given by

P_{φi}=ρA_{φ1}V_{φ1}³/2 (30)

By combining Equations (3) (4), and (30) we obtain

P_{φ2}=k_{f}²P_{φi} (44)

Important Thus, according to Equations (8), and (44), the higher the value used for the parameter k the higher will be the fluid velocity multiplier k_{f} and the fluid power Pᵥ applied to the turbine blades. In conventional design of horizontal axis wind turbines the oncoming wind power P_{φi} is applied directly to the turbine blades. In contrast, in our Accelerated Wind Turbines we apply first the oncoming wind power P_{φi} to the FA chamber to increase it k_{f}² times up to the power P_{φ2} which is then applied to the turbine blades. As a result the power P_{φ2} of the fluid impacting the wind turbines can be made many times bigger than the power P_{φi} of the external wind. This in turn results in accelerated wind turbines with much higher efficiency than conventional HAWT machines.

In what follows it must be stressed that if an AF machine is shown as implemented solely with fans, it is clear that it can also be implemented with thermal airfoil turbines, and vice versa.

Energy Space A vehicle moving in a fluid with a certain velocity V_{φ1} gives rise to a flow of such a fluid at the same velocity. The flow is present in a certain finite neighborhood in contact with the moving vehicle. On account that this fluid flow contains thermal and kinetic energy, the space surrounding this vehicle can be considered as an energy space. The extent, boundaries and properties of the energy space at each point have as yet to be evaluated. However it is apparent that a suitable AF machine placed in the vehicle in motion and in contact with this energy space will be able to extract part of the energy contained in the latter.

Fluid Panel We define a fluid panel as any structure composed of more than one AF machine forming a wall or flat panel that can be attached to a vehicle or placed on a platform or on a stationary building for the purpose of capturing part of the energy contained within the surrounding energy space. Typically a fluid panel can be a Wind Panel or a Water Panel if the fluid in the energy space is a wind, or water, respectively. In the first case, the wind panel is attached to a vehicle, fixed building, or platform immersed in the energy field. Typically it can be mounted at the roof or on the sides of the vehicle and facing the wind, or it can be submerged in water if the vehicle moves in this medium

Fluid panels can alternatively be placed on a stationary structure, such as the roof of a house or building to extract energy from the wind or can be submerged and attached to the bottom of a body of water such as a stream, river, sea, etc., to extract energy from the underwater flows. A basic building block that can be used to implement a fluid panel is shown in FIG. 17 containing 8 electric fans. As to the maximum number of fluid turbines or fans that can be used in a building block this is has to be determined experimentally as it is related to the shear stress developed in walls and blades. There can be a least one turbine or fan. FIG. 21 shows a fluid panel, consisting of 8 AF machines each with 8 electric fans for a total of 64 electric fans, each of them operating as a generator fan. The bi-directional arrows show the direction in which the fluid can flow and produce an electric current in the electric fan leads. It is possible to combine two or more single fluid panels like the one shown in FIG. 21. For example, FIG. 22 shows a compound fluid panel consisting of two fluid panels placed orthogonally with each other to capture flows in 4 possible geographical directions. Other geographical directions can be covered with more fluid panels placed one on top of another and oriented in the desired directions. Of course, if the number of panels is increased so does the power that can be generated. For example, is the AF machines used in the fluid panel of FIG. 21 were all identical accelerated wind turbines, each generating 1 kW, then the total power generated by the fluid panel would be 8 kW. As to the maximum number of fluid panels that can be placed one above another there is no limit, except for the maximum weight that the building or platform can support or the maximum drag force the vehicle can withstand.

Fluid Electric Generator A Fluid Electric Generator (FEG or FE generator) is an AF machine that produces electric energy out of a previously accelerated fluid flow. To implement the FEG two fundamental elements are required: First, an accelerated fluid flow within the Venturi-like throat; Second, one or more electric fans placed coaxially within the latter in such a way that their hub diameters coincide with the diameter d of the inner cylinder, and the fan blades occupy partly or totally the empty space of width (D−d)/2 in the throat as is shown in FIG. 6(c), and FIG. 10(c).

At least one of the electric fans placed coaxially within the throat has to be operated as a generator fan or turbine, i.e., its electric leads are not connected to a power supply but instead they are left open or connected to an electric load, and its blades are allowed to rotate as the result of being impacted by the accelerated fluid.

There are basically two ways for accelerating a fluid flow, namely: 1. by allowing the surrounding fluid external to the machine to enter the fluid acceleration chamber where it is accelerated on account of the continuity equation. In this case the FA chamber has the function of capturing part of the fluid surrounding the machine; 2. By artificially generating the fluid flow inside the Venturi like throat by operating one or more fans as motors proper. This is simply done by connecting the motor fan electric leads to a power supply. In the first case, the fluid flow is accelerated within the fluid acceleration chamber reaching its final velocity V_{φ2} at the throat. When the fluid flow is artificially created, the fluid acceleration chamber can be open or closed. This can be done with the arrangement shown in FIG. 17, where one or more electric fans placed inside the throat are operated as motors to create or reinforce the fluid flow. At least one of the fans has to be operated as a generator, i.e., as a turbine to produce the output mechanical or electrical power.

In another arrangement, it is possible to place an electric fan with a diameter not greater than D₁=D+kd at the entrance of the FE generator, as is shown in FIG. 19 in which the fluid flow is created by the electric fan F placed at the left entrance. Electric fans F₁, F₂, and F₃ can all work as generator fans or one or more of them can operate as motor fans to reinforce motor fan F and accelerate further the fluid inside the throat.

Take notice that for accelerated wind turbines and for water electric generators fan F at left entrance in FIG. 19 has to be removed, and all the electric fans are placed in the throat (straight section of the FE generator) where the fluid velocity is a maximum, as is shown in FIG. 18 for an accelerated wind turbine, or in FIG. 20 for an accelerated water machine, or water motor. If turbines T1 and T2 are attached to an electric generator (not shown), the water motor becomes a fluid electric generator that can be used as a Vertical Water Electric Generator (See also FIG. 24 and Section A Vertical Accelerated Water Machine). On the other hand, a horizontal FEG that can be used as a Horizontal Water Electric Machine is shown in FIGS. 17 and 25.

In all fluid electric generators the power supply used by the motor fans can be either ac or dc, depending on whether the fan motor is an ac machine or a dc one. Also, in an FE generator the generator fan outputs can be connected in series to obtain the total generated voltage as the sum of the individual voltages generated by the fluid turbines. In addition, if two or more fan motors are used to generate the accelerated fluid, they can be connected in parallel in order to increase the speed of the accelerated fluid within the throat. As to the number of fans that can be used there can be as few as one or as many as there can be physically placed within the throat. The fans can all be placed onto the same shaft in whose case they all rotate at the same angular velocity. Or, they can be physically separated although maintaining its co linearity.

Both in the vertical water electric generator (WE generator), shown in FIGS. 20 and 24, as well as in the horizontal WE generator, shown in FIGS. 17 and 25, all fans are operated as generator fans. The diameter of the nozzles is chosen as D+kd, where k is an integer ≧0. The length lₜ of the top and bottom nozzles in the vertical WEG can be calculated from Eq. (9) but the top nozzle can be shorter than the bottom one on account of the fact the water flow is accelerating in the top nozzle but is decelerating in the bottom one which implies there is usually less turbulence in the top termination than in the bottom one.

Accelerated Wind Turbine A particular form of a fluid electric generator is the Accelerated Wind Turbine (AWT or AW turbine), an example of which is shown in FIG. 18. It is an AF machine in which the external wind can enter through either one of its nozzle terminations. In the AWT mode of operation all of the motors of the fans (F₁, F₂, etc.) are disconnected from the power supply and the wind velocity is increased in any of the nozzles from its external value V_{φ1} up to the maximum value V_{φ2} and then is conducted to the throat where it impacts the rotary blade set of the electric fans, The fan blades are then rotated by the accelerated wind, and as a result a voltage is induced in the electric leads of the fans that now operate as generator fans (i.e., like turbines). There can be as many fans as needed to achieve the required output power. The total induced voltage is equal to the sum of the individual voltages generated by the generator fans if these are connected in series.

By applying the continuity equation we can readily show that the relationship between wind speeds V_{φ1} and V_{φ2} is given by either one of the following equations

V_{φ2}=k_{f}V_{φ1} (15)

Where k_{f} is given by Eq. (8) as

k_{f}=(D+kd)²/(D+d)(D−d) (8)

Example Assuming k=1, V_{φ1}=20 Km/h; D=0.5 m, and d=0.31 m, we get D+d=0.81 m; V_{φ2}=85.26 km/h. In other words, the fluid acceleration chamber in this case multiplies the entering wind speed by a factor greater than 4, which leads to a considerable increase in the generated power and efficiency of the AW turbine, as can be seen from Eq. (29) and Eq. (39) in Sections Mechanical Power Calculations and Calculation of the Mechanical Power Gain for an AF Machine.

Notice that in order to achieve a higher output power in a conventional horizontal axis wind turbine (HAWT), usually the size (length) of the blades is augmented to increase the area swept by the blades. However, usually no attempt is made to obtain higher output power by increasing the velocity of the incoming wind before it impacts the blades. In contrast, in our Accelerated Wind Turbine, the velocity of the wind outside is increased in the fluid accelerating chamber by a speed multiplying factor k_{f}, given by Eq. (8). This approach of raising the wind speed to increase the wind turbine efficiency is much more effective and economical than making the blade size bigger, taking into account that output power is proportional to the cubic power of the wind speed striking the blades, as shown in Eq. (28), Section Mechanical Power Calculations, and that a bigger blade means a heavier one, a greater moment of inertia Iₜ, and hence, a lower turbine rotational velocity n, and a smaller generated power P_{g}, as shown by Equations (27) and (28).

Electrical Power Calculations The Fluid Electric Generator can be viewed as a system with one input and one output. The input is the electrical power applied to the electric motor or motors (by a battery, mains or a power supply). The output is the useful electrical power developed at the electric load. Also, we can view the FEG initially as composed of two main active components, namely, one equivalent electric motor, and one equivalent electric generator. The purpose of the electric motor is to produce the accelerated fluid. The purpose of the electric generator is to extract energy from the accelerated fluid and to convert it into electrical energy. Thus we can represent the FEG by the model shown in FIG. 23, assuming for convenience that the motor and the generator are DC machines. A similar analysis can be derived for AC machines. We also assume that the load resistance R_{L} is matched to the generator Rₒ for maximum power transfer.

We define the electrical power gain of the FEG as

Gₚₑ=Pₒ/Pᵢ (45)

Where Pₒ is the electrical power developed by the machine at the load resistance R_{L}, and Pᵢ is the electrical power applied by the power supply to the electric motor.

Self Sustainable Fluid Electric Generator The FEG machine can operate as a self sustainable generator if the electrical power gain Gₚₑ is greater than unity. In the following we will show that the FEG will be self sustainable if a certain relationship among the motor input resistance Rₕ the generator output resistance Rₒ, the applied input voltage vᵢ and the electromotive force v_{g} is fulfilled. For the worst case of maximum input power, the counter electromotive force v_{gc}=0, and

Pᵢ=vᵢ²/Rᵢ (46)

But, for maximum power transfer it can be shown that

Pₒ=v_{g}²/(4Rₒ) (47)

For self sustained operation, it is required that

Gₚₑ>1 (48)

This in turn requires that

Pₒ>Pᵢ (49)

Or

v_{g}²/(4Rₒ)>vᵢ²/ (50)

From Eq. (50), we finally obtain the condition required for the FE generator to be self sustainable as

v_{g}>2(Rₒ/Rᵢ)^{1/2}vᵢ (51)

Example If the motor and the generator are chosen such that Rₒ=10⁻²R₁, then for self sustained operation, it is required that

V_{g}>0.2vᵢ

An Experimental Result FIG. 30 shows schematically an Air Electric Generator implemented with ordinary commercially available electric fans, like the ones shown in FIG. 13, and tested. Five electric fans were operated as generator fans, namely, G1, G2, G3, G4, connected in series, and. G5, connected in parallel. All of the fans used were DC brushless axial fans of three different types. Fans G1, G2, G3, and G4 were 48 V 0.45 A fans, with dimensions: 120 mm×120 mm×38 mm, and each having an internal (measured) resistance of about 340 Ohm. On the other hand, fans M1, M2 and M3 were used as motor fans and connected in parallel to generate the airflow. These were 48V 3A fans with dimensions 120 mm×120 mm×38 mm, and each having an internal (measured) resistance of about 60 Ohm. Referring to the equivalent circuit for motors and generator fans (FIG. 23), the total internal resistance of the motor fans was 13; =20 Ohm. The total output resistance of generator fans connected in series was 1360 Ohm. In order to fulfill the condition for self sustaining movement, as stated in Inequality (44), it was necessary to reduce this large resistance to about Rₒ=5.25 Ohm. This was done so by connecting fan G5 in parallel with the series combination of generator fans G1, G2, G3, and G4. Fan G5 had the following features: 12 V, 4.40 A, dimensions: 120 mmx120 mmx38 mm, and with an internal (measured) resistance of about 5.25 Ohm. The following experimental results were obtained with the arrangement of FIG. 30:
Input voltage: vi=14.95 V
Output voltage in open circuit: 15.54 V
Input power Pi=11.18 W
Output power Po=11.5 W

Since Inequality (49) was fulfilled we conclude that this rather rudimentary AE generator just behaves as a self sustainable machine.

A Vertical Accelerated Water Machine The Vertical Accelerated Water Machine is just an open chamber accelerated fluid machine positioned in a vertical or upright position between a superior reservoir or water tank 1, and an inferior reservoir or water tank 2, as shown in FIG. 24. Both tanks can have similar dimensions and, for simplicity and ease of mass manufacturing the machine, we will make D₁=D₂=D+kd, and h₁=h₅. In the example shown in FIG. 24, eight fans have been placed within the throat. However, there can be as few as one fan and as many as there can be placed in length l_{f} of the throat. If all the fans are mechanical, i.e., if they just generate mechanical energy, the vertical accelerated water machine becomes a Vertical Accelerated Water Motor, or just a Water Motor (WM) for short. But, if the fans are electrical and some or all of them convert the energy extracted from the water flow into electric energy, them the machine becomes a Vertical Accelerated Water Electric Generator or simply a Water Electric Generator (WEG or WE generator) for short.

We will assume that water tank 1 is large (compared to nozzle diameter D₁), and in contact with the atmosphere both at level 0 and at level 1, where some tiny perforations can be made to allow the entrance of air but not water leak. Therefore pressure at level 0 of water tank 1 is P₀=0, and at level 1 is p₁=0. Water velocity at level 0 is V₀=0, and at level 1 is:

V₁=√[2gh₀] (52)

But according to the continuity equation, water flow velocity al level 2, is given by

V₂=A₁V₁/A₂ (53)

Where the cross sectional areas A₁ and A₂ seen by the falling water stream at levels 1 and 2 are

A₁=π(D+kd)²/4 (54)

A₂=π(D+d)(D−d)/4 (55)

V₂=(D+kd)²V₁/[(D+d)(D−d)] (56)

Let us note that water velocity at level 2 is obtained by multiplying velocity at level 1, V₁, by the Water Velocity Multiplier factor k_{f}, given by

k_{f}=[(D+kd)²/(D+d)(D−d)] (8)

Which is always greater than 1 if 0<d<D, which is always the case for an AF machine.

Length h₁ of the AWM has to be chosen to prevent cavitation from taking place, i.e., we have to make sure that water pressure al level 2, p₂, satisfies the following relationship

p₂>Water vapor pressure pᵥ=−97.09 kPa, at 30° C. (57)

On the other hand, by applying Bernoulli Equation to a water flow line between levels 1, and 2, we obtain, assuming a steady, inviscid, and incompressible flow,

p₂=(1/2)ρ(V₁²−V₂²)+ρgh₁ (58)

p₂=(ρ/2)(V₁²)(1−k_{f}²)+ρgh₁>pᵥ (59)

h₁=(1/ρg)p₂+(k_{f}²−1)h₀ (60)

For the accelerated water machine to be realizable it is required then that

p₂>pᵥ (61)

And

h₁>0 (62)

Let us now define p₂ₘᵢₙ as the minimum value of pressure p₂ that makes height h₁ as given by Eq. (60) equal to cero.

Thus, from Eq. (60) we have

p₂ₘᵢₙ=(1−kf²)(ρgh₀) (63)

Let us now define k_{fmax} as the maximum value of k_{f} for which p₂ₘᵢₙ=pᵥ. This is an upper bound for factor k_{f} to fulfill realizability conditions:

p₂>p₂ₘᵢₙ>pᵥ (64)

h₁>0 (65)

And

k_{f}<k_{fmax} (66)

Thus

k_{fmax}=[√−(pᵥ/μgh₀)] (67)

If Inequalities (64) and (66) are satisfied, cavitations will not take place.

Example: Let us suppose h₀=0.3 m, D=0.5 m, and d=0.3 m, ρ=995.7 Kg/m³, g=9.8 m/s², then

k=1:

k_{fmax}=5.85

k_{f}=4<k_{fmax}

k=2:

k_{fmax}=5.85

k_{f}=7.56>k_{fmax}

So, we discard k=2, and take k=1. Then

V₁=√[2(9.8)(0.3)]=2.42 m/s

V₂=k_{f}V₁=9.70 m/s

And

p₂ₘᵢₙ=(1−k_{f}²)(ρghₒ)=−43,910.37 Pa

Let us take

p₂=−40,000.00 Pa>−43, 910.37 Pa>pᵥ=−97,090 Pa

Then,

h₁=(1/ρg)p₂+(k_{f}²−1)h₀=0.40 m

Take notice that in order to get V₂=9.70 m/s with a free water jet using just gravity, the required tank depth h₀ plus the termination length h₁ would have been:

h₀+h₁=V₂²/(2g)=4.8 m

Whereas with the water motor for achieving the same speed it is only required that

h₀+h₁=0.3+0.4=0.7 m, and p₂=−40 KPa,

An 85.42% height reduction! This is a definite advantage of our accelerated water machine over conventional hydraulic machines, and can be achieved by simply by making h₁>0, and p₂>p₂ₘᵢₙ.

By applying Bernoulli Equation at levels 2 and 3 and noticing that V₂=V₃, we get

p₃=P₂+ρgh₂ (68)

If p₂>pᵥ, then p₃, p₄, etc., will all be greater than pᵥ, and no cavitations will take place.

Example Assuming h₂=0.25 m, and the same geometrical parameter values as before, we get

p₃=p₂+ρgh₂=−40,000.00+(995.7)(9.8)(0.25)

p₃=−37,560.54 Pa>pᵥ=−97,090 Pa

Power Calculations for a Vertical AW Machine Let us suppose that Nₜ identical axial fans (water turbines), each with N_{b} blades, are placed within the water velocity enhancer of cross-sectional area A₂ given by Eq. (55). Then for the following parameters, with just one turbine (Nₜ=1), having N_{b}=8 blades, blade coefficient values: C_{D}=0.040163; C_{L}=0.46852, blade span s=0.09 m; blade chord c=0.175 m, D=0.5 m, d=0.3 m, φ=45°, h₀=0.15 m, n=900 rpm, and by applying Equations (8), (52), (53), (19), (30), (29), (38), (63), (67), (60), and (9), we obtain, respectively, the results shown in Table II for the parameter k_{f}, fluid velocities V₁ and V₂, relative fluid velocity V_{φ}, input flow power P_{φi}, generated mechanical power P_{g}, mechanical power gain Gₚₘ; p₂ₘᵢₙ; k_{fmax}; h₁, and nozzle length lₙ. The calculations were done for two values of parameter k, namely, k=1, and k=2, and assuming p₂=−18,000 Pa>p₂ₘᵢₙ; ρ=995.7 kg/m³; g=9.8 m/s².

For k=1, generated power P_{g} (37.438 kW) is much greater than input power P_{φi} (1.262 kW), and can be used to drive an electrical generator, which in turn can be used to power a pump and the remaining electric appliances of the house. Alternatively the pump can be driven directly by the rotary water turbines. Thus for this particular AW machine it is possible to achieve self sustained motion (Gₚₘ=29. 68>1), and generate a mechanical power of 37.438 KW. Of course, the power generated can be increased by a factor Nₜ simply by using Nₜ>1 water turbines. Even substantially better results are obtained for k=2, as can be seen from the results of Table II. Since for k=1, lₙ turned out to be greater than h₁, the length of the top nozzle is taken as h₁=0.41 m rather than lₙ=0.95 m, with very little increase in turbulence as the water flow accelerates in the upper nozzle.

TABLE II
Power calculation results for a Vertical Accelerated Water Machine

| k | k_{f} | V₁, m/s | V₂, m/s | V_{φ}, m/s | P_{φi}, W | P_{g}, W | Gₚₘ | p₂ₘᵢₙ, Pa | k_{fmax} | h₁, m | lₙ, m |
|---|---|---|---|---|---|---|---|---|---|---|---|
| 1 | 4 | 1.71 | 6.86 | 9.70 | 1,262 | 37,438 | 29.68 | −21,955 | 8.21 | 0.41 | 0.95 |
| 2 | 7.56 | 1.71 | 12.97 | 18.34 | 2,385 | 133,822 | 56.11 | −82,246 | 8.21 | 6.58 | 1.89 |

Realizability Conditions for the Vertical Accelerated Water Machine It is important to take into account that in order to make realizable the accelerated water energy machine the following conditions have to be satisfied

hₒ>0 (69)

h₁>0 (70)

p₂>p₂ₘᵢₙ (71)

And p₂ₘᵢₙ is given by Eq. (63) for the symmetric AW Machine. Equation (69) implies that water tank 1 can never be allowed to empty. If a water pump is used for replenishing water tank 1 it is required then that the refill time of the latter must be less than the time required to empty it. Accordingly the water flux Qₚ from the water pump has to be greater than the water flow Q₁, that is to say

Qₚ>Q₁ (72)

Where

Q₁=A₁V₁ (73)

A Horizontal Water Machine An open chamber horizontal water machine can be implemented using an open chamber AW machine like the one shown in FIGS. 6 and 10. It can be stationary or mobile. In the first case they can be placed and fixed under the water surface or on the bottom of the sea, river or lake to operate with tidal, submarine or under water currents. In the second case, it can be implemented with axial electric fans as shown in FIG. 25. The machine must be submerged in water and attached to a moving sea, lake or river vehicle to take advantage of the speed of the moving vehicle that gives rise to a water flow that can be captured and accelerated by the converging nozzle of the machine. Any water vessel, like a ship, a submarine, etc., can carry under the water surface and attached to it an open chamber Water Electric Generator to generate partially or totally the electricity required by the vessel. (See FIG. 36).

The design of a horizontal water electric generator is very similar to that of the vertical water electric generator as explained in Section A Vertical Accelerated Water Machine, except that gravity has no effect now. Additionally the water pressure P₀ at depth hₒ and at the entrance of the machine is

pₒ=μgh₀ (74)

This is greater than atmospheric pressure, as can be seen from FIG. 25.

Consider the horizontal water electric generator shown schematically in FIG. 25 containing 3 electric fans and submerged at a depth h₀.

For the water flow line between positions 0 and 1 inside the WE generator, and assuming steady, inviscid, and incompressible flow Bernoulli Equation can be written as

pₒ+ρ(V₀²)/2=p₁+ρ(V₁²)/2

Hence

P₁=Pₒ−ρ(V₁²−V₀²)/2

But

V₁²=k_{f}²V₀²

And

V₀=V_{φi}

And k_{f} is given by Eq. (8). Then

p₁=pₒ−ρ(k_{f}²−1)V₀²/2 (75)

If V₀ and hₒ are known, then k_{f} must be chosen to make sure that p₁ will be greater than pᵥ=−97,090 Pa to prevent the occurrence of cavitations.

Thus

k_{fmax}=√{1+[2(p₀−pᵥ)/ρV₀²]} (76)

And

V₀ₘₐₓ=√{2(P₀−Pᵥ)/[ρ(k_{f}²−1)]} (77)

Of course, the higher the value of pₒ, the higher can be the values of k_{fmax} and V₀ₘₐₓ.

Radial Fans In FIGS. 26(a) and 26(b) two commercially available radial fans are depicted, and in FIG. 26(c) a schematic diagram of them is shown. The inlet is where the fluid usually enters the fan, and the outlet is where the fluid usually comes out of the fan. The inlet consists of the eye and the rotary blades. As the blades rotate fluid is sucked in through the casing eye, flows in a radial fashion outward and comes out through the outlet or discharge. The outlet cross-sectional area can be round or rectangular.

Open Fluid Acceleration Machine with Radial Fans The open fluid acceleration machine using radial fans can be implemented by connecting by their straight section two radial fans like the ones shown in FIG. 26, and placing the Venturi-like throat for axial fans in the straight section as shown in FIG. 27. This is an open chamber FE generator, implemented with two radial electric fans, one operating as a motor fan and the other operating as a generator fan. Additionally 4 electric axial fans are placed within the fluid acceleration chamber positioned in the straight section joining both radial fans. The axial fans can all work as generator fans or some of them can work as motor fans and the others as generator fans. Of course there can be less or more than 4 axial fans in the throat.

Tandem Accelerated Fluid Machines Two or more AF machines of different cross-sectional areas, like the ones shown in FIG. 28 can be connected together in tandem, using an arrangement similar to the one shown in FIG. 29. The requirement for achieving this interconnection is that the throat external diameter of both machines satisfies the following relationship

D₂+k₂d₂=D₁ (78)

Where D₁ is the throat diameter of the machine 1, as shown in FIG. 28(b), D₂ and d₂ are, respectively, the outer and inner diameter of the throat of machine 2, and k₂ is an integer (k₂=0, 1, 2, 3, . . . ). And the larger diameter of nozzles of machine 1 is given by

D₁+k₁d₁ (79)

Where k₁ is an integer (k₁=0, 1, 2, 3 . . . ).

On the other hand, if the fluid speed at the entrance of AFM1 nozzle is V_{φ1}, then the fluid speeds in AFM1 throat and AFM2 throat are, respectively,

V_{φ1}=k_{f1}V_{φi} (80)

V_{φ2}=k_{f2}V_{φ1}=k_{f1}k_{f2}V_{φ1} (81)

Where k_{f1} and k_{f2} are given from Eq. (8) by

k_{f1}=(D₁+k₁d₁)²/[(D₁+d₁)(D₁−d₁)] (82)

k_{f2}=(D₂+k₂d₂)2/[(D₂+d₂)(D₂−d₂)] (83)

Eq. (81) can be generalized for j turbines in tandem (j=2, 3 . . . etc.), and the fluid velocity in throat of nth turbine can be written as

V_{φj}=k_{f1}k_{f2} . . . k_{fj}V_{φ1} (84)

Where

k_{fj}=(Dⱼ+kⱼdj)²/[(Dj+dj)(Dj−dj)] (85)

Of course if powers generated separately by each AF machine are P_{g1}, P_{g2}, P_{g3}, etc., the total power P_{g} generated by j machines in tandem will be

P_{g}=P_{g1}P_{g2}+ . . . =.P_{gi} (86)

Closed Chamber for AF Machines Accelerated Fluid Machines can also be implemented in closed chamber, where the operating fluid (typically air or water) is confined and not allowed to escape to the environment. Two possible shapes for the closed chamber that can be used for axial fans and thermal airfoil turbines are the constant cross-sectional area toroids, shown in FIG. 31. FIG. 31(a) shows the plan view of an empty chamber toroid, the 2-leg (180° bends) toroid, with gradual transitions between the straight sections and the curved sections. FIG. 31(b) shows the plan view of another empty chamber toroid, the 4-leg (90° bends) toroid. FIG. 32 shows a fluid voltage generator consisting of two tandem identical AF machines, like the one shown in FIG. 29, each placed in the straight section of a 2-leg toroid and consisting of 4 small turbines of diameters D₂ and d₂ plus two larger turbines of diameters D₁ and d₁. In addition, two large similar electric fans, each of diameter D₁+kd₁, are placed in the middle of the curved section of the toroid for the purpose of creating the fluid that will make the turbines spin, after being accelerated in the accelerating nozzles Nᵢ and N₃. The fluid created by the fans is made to circulate in a single direction, for example clockwise and is decelerated in diverging nozzles N₂ and N₄. FIG. 33 shows another closed chamber fluid voltage generator using a couple of electric fans, of diameter D₁+kd₁, each positioned in a curved section of the toroid. Additionally, two identical tandem AF machines are placed in the straight sections of the toroid. Each tandem machine contains two small turbines of diameters D₂ and d₂ plus two larger turbines of diameters D₁ and d₁. To minimize turbulence arising in the 90° bends due to the variation of centrifugal force therein curved concentric stationary cylindrical vanes are placed inside each curved section.

A third shape for the closed chamber that can be used with radial (centrifugal) fans consists of two identical open chamber AF machines for radial fans, like the one shown in FIG. 34(a), placed side by side, one against the other in such a way as to close all the eye openings to prevent from any fluid leakage, as is shown in FIG. 34(b).

The closed fluid acceleration chamber can be used in all AF machine applications, except for wind generator applications that require an open chamber. On the other hand, the open fluid acceleration chamber in any of its varieties can be used in all AFM applications including accelerated wind turbine applications.

Industrial Applicability In the next six sections various possible applications of the accelerated fluid machines are proposed.

Mobile AF Machines in Land, Air, and Sea Vehicles Any moving land, air or water vehicle can generate all or part of the electricity it requires by using an Accelerated Fluid Electric Generator, either in open chamber or in closed chamber fashion, attached to the structure of the vehicle. In FIGS. 35 and 36 some applications of the open chamber accelerated fluid machine are shown. In all of these applications the speed of the fluid entering the open chamber accelerated fluid machine is the same as the velocity of the vehicle. However the fluid velocity is further increased within the FA chamber of the AF machine. Alternatively, a fluid panel containing several AF machines to capture part of the surrounding fluid flow can be mounted on the vehicle instead of a single AF machine.

A Battery of Water Electric Generators For high power requirements, a battery of several water electric generators fed from the same water tank or reservoir can be used, as is shown in FIG. 37. Alternatively, a water panel can be placed horizontally submerged under any body of water where there are underwater currents

An Accelerated Wind Turbine Array For capturing wind coming from several directions, several Accelerated Wind Turbines each pointing at a different direction can be placed in horizontal platforms separated vertically from each other, as shown in FIG. 38, or one on top of the other separated by a tray, as is shown in FIG. 39. The array can also be formed with one or more wind panels, as described in Section Fluid Panel

### BRIEF DESCRIPTION OF DRAWINGS

The drawings are not referenced to any scale and do not have a referenced scale among them.

FIG. 1 shows the forces acting on a blade when impacted by a fluid with velocity V_{φ}

FIG. 2 shows schematically 4 possible shapes of a FA chamber or converging nozzle and its constituent parts

FIG. 3 shows schematically 4 possible shapes of an exhaust chamber or diverging nozzle and its constituent parts

FIG. 4 shows schematically some truncated cones that coaxially conform with a central cone (shown in FIG. 2(d), and FIG. 3(d)) either a converging or a diverging nozzle

FIG. 5 shows schematically a convergent flow sub-path formed with two coaxial truncated cones (TC7 and TC8) for improving the laminarity of the flow path

FIG. 6 shows schematically (a) a longitudinal view of an AF machine containing two turbines and two fluid straighteners; (b) a frontal view of the AF machine; (c) a cross sectional view of the Venturi-like throat of the AF machine

FIG. 7 shows schematically (a) a frontal view of an aerodynamic fluid turbine containing 8 airfoils; (b) a side view of the turbine

FIG. 8 shows schematically a fluid straightener and some of its constituent parts

FIG. 9 shows schematically (a) a longitudinal view of a simple AF machine having 2 fluid turbines, 2 flow straighteners and no nozzles; (b) a cross-sectional view of the Venturi-like throat of the AF machine

FIG. 10 shows schematically (a) a longitudinal view of an AF machine containing four fluid turbines and no fluid straighteners; (b) a frontal view of the AF machine; (c) a cross-sectional view of the Venturi-like throat of the AF machine

FIG. 11 shows schematically (a) a longitudinal view of a simple AF machine having a single fluid turbine; (b) Forces acting on a fluid turbine blade element, and velocities and angles involved

FIG. 12 shows schematically (a) a frontal view of a mechanical axial fan; (b) a lateral view of an electric axial fan showing its motor M

FIG. 13 shows the frontal and rear view of a typical axial fan moved by an electric dc brushless motor placed centrally in its stator

FIG. 14 shows schematically two building blocks for implementing AF machines and fluid panels using electric fans, namely, (d) flow straightener enclosed in box; (e) electric fan enclosed in box

FIG. 15 shows schematically two building blocks for implementing AF machines and fluid panels using electric fans, namely, (d) diverging nozzle enclosed in box; (d) converging nozzle enclosed in box

FIG. 16 shows a schematic diagram of (a) a longitudinal view of an AF machine implemented with four fluid straighteners and four electric fans; (b) a longitudinal view of an AF machine implemented with eight electric fans and no fluid straighteners

FIG. 17 shows schematically a longitudinal view of an AF machine (air electric generator), implemented with eight electric fans and no fluid straighteners

FIG. 18 shows schematically the longitudinal views of two possible implementations of an accelerated wind turbine built with (a) five flow straighteners and four thermal airfoil turbines; (b) five flow straighteners and four electric fans

FIG. 19 shows schematically (a) the front view of an air motor implemented with a large fan at entrance of FA chamber, two thermal airfoil turbines and two fluid straighteners; (b) the longitudinal view of the air motor; (c) the front view of an air electric generator implemented with two electric fans and two flow straighteners; and (d) the longitudinal view of the air electric generator

FIG. 20 shows schematically a symmetric vertical water motor with two thermal airfoil turbines and three fluid straighteners.

FIG. 21 shows schematically a fluid panel consisting of 8 AF machines each containing 8 electric fans. This fluid panel can be used as a wind panel or as a water panel to generate electricity out of wind or water

FIG. 22 shows schematically two floors of vertically separated fluid panels covering fluid flowing in four geographical directions containing a total of 128 electric fans.

FIG. 23 shows the equivalent circuit of a fluid electric generator

FIG. 24 shows a schematic diagram of a vertical accelerated water electric generator

FIG. 25 shows schematically a horizontal water electric generator submerged at a depth h₀ (For underwater electrical energy generation)

FIG. 26 shows two typical radial fans and their schematic representation

FIG. 27 shows schematically four possible implementations of an open AF machine using 2 radial fans and 4 axial fans placed in the straight section of the radial fans

FIG. 28 shows in perspective two AF machines with different dimensions that can be interconnected to form a tandem AFM; (a) longitudinal view of AFM 1; (b) frontal view of throat of AFM 1; (c) longitudinal view of AFM 2; (d) frontal view of throat of AFM 2

FIG. 29 shows a longitudinal view of a tandem AF machine containing 2 large turbines pertaining to the AFM 1 stage, and 4 smaller turbines pertaining to AFM 2 stage

FIG. 30 shows schematically an experimental tandem air electric generator; (a) Rear view; (b) Front view; (c) Longitudinal view

FIG. 31 shows schematically (a) empty chamber of a closed chamber toroidal fluid electric generator; with gradual transitions between the straight sections and the curved sections (two 180° bends); (b) empty chamber of a closed chamber toroidal fluid electric generator; with four 90° transitions between the straight sections and the curved sections

FIG. 32 shows schematically a closed chamber fluid electric generator with two 180° bends. It includes two identical tandem AF machines and can be used to generate electricity from air or water circulating within by the action of fans F1 and F2

FIG. 33 shows schematically a closed chamber fluid electric generator with four 90° bends. It includes two identical tandem AF machines. and can be used to generate electricity from air or water circulating within by the action of fans F1 and F2

FIG. 34 shows schematically (a) a diagram of an open chamber FEG using 2 radial fans with eyes on opposite sides and 4 axial fans placed in the straight section joining both radial fans; (b a tri-dimensional view of a closed chamber accelerated fluid machine for radial fans

FIG. 35 shows schematically an aircraft with an accelerated wind turbine on its top FIG. 36 shows a cargo ship carrying a stack of 5 wind voltage generators on deck and a submerged horizontal water electric generator

FIG. 37 shows schematically a battery of six vertical water electric generators

FIG. 38 shows a schematic diagram of a wind voltage generator array

FIG. 39 shows schematically two orthogonally placed AW turbines

FIG. 40 shows schematically side views of (a) an HAWT machine; (b) an AWT machine

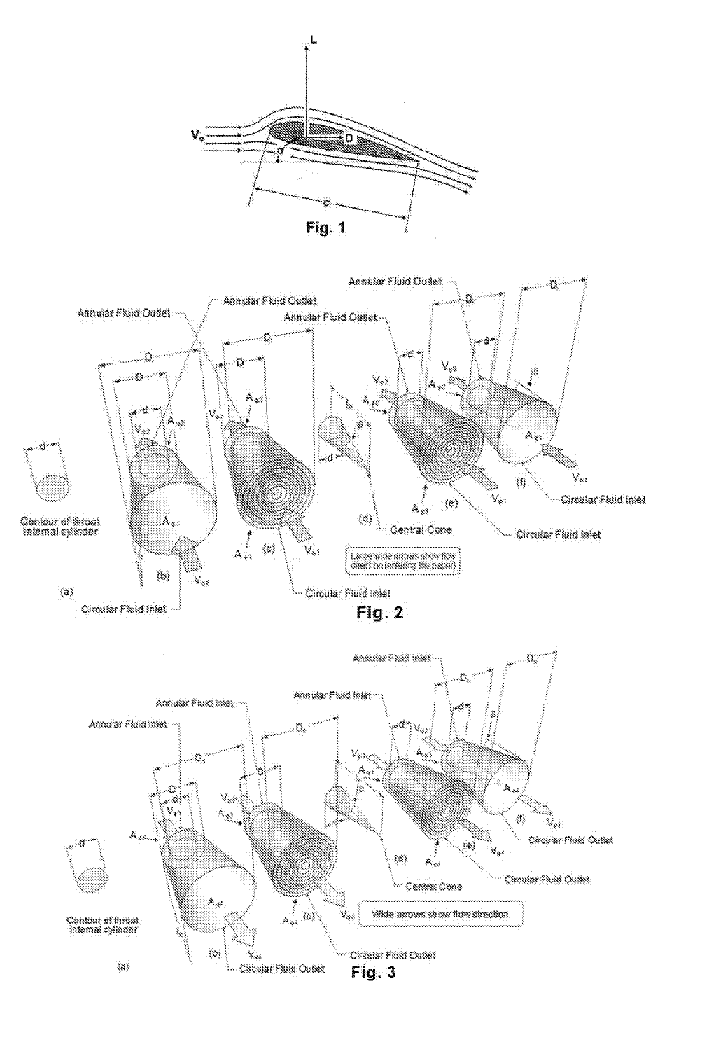

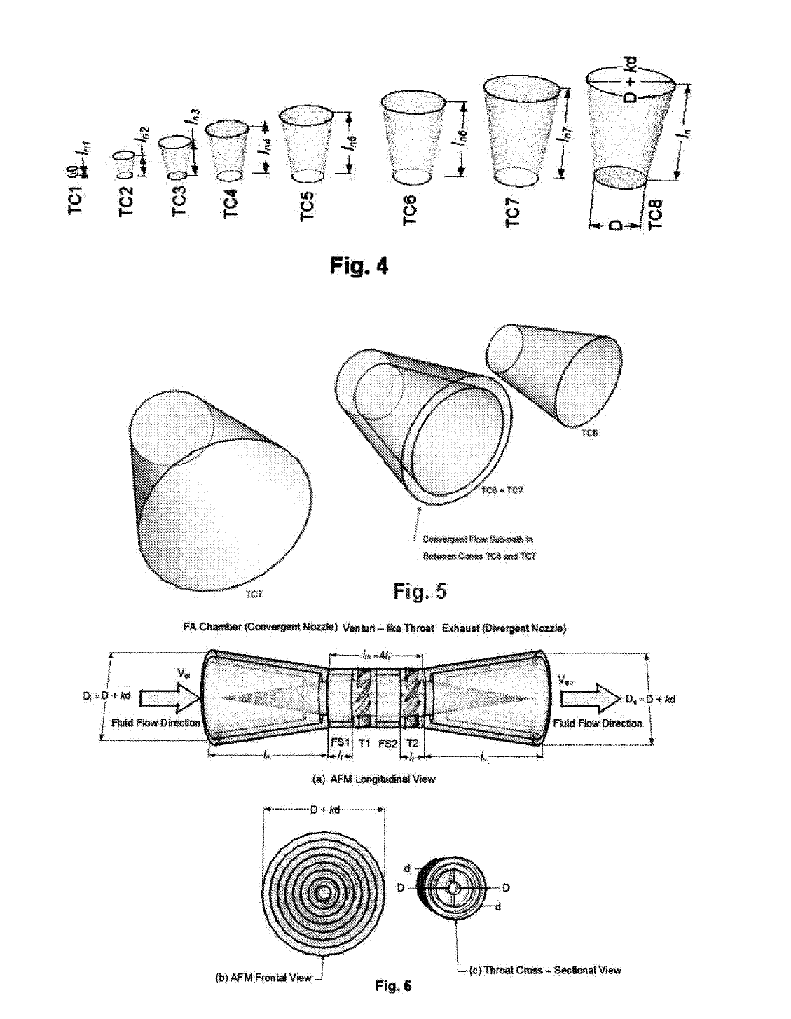

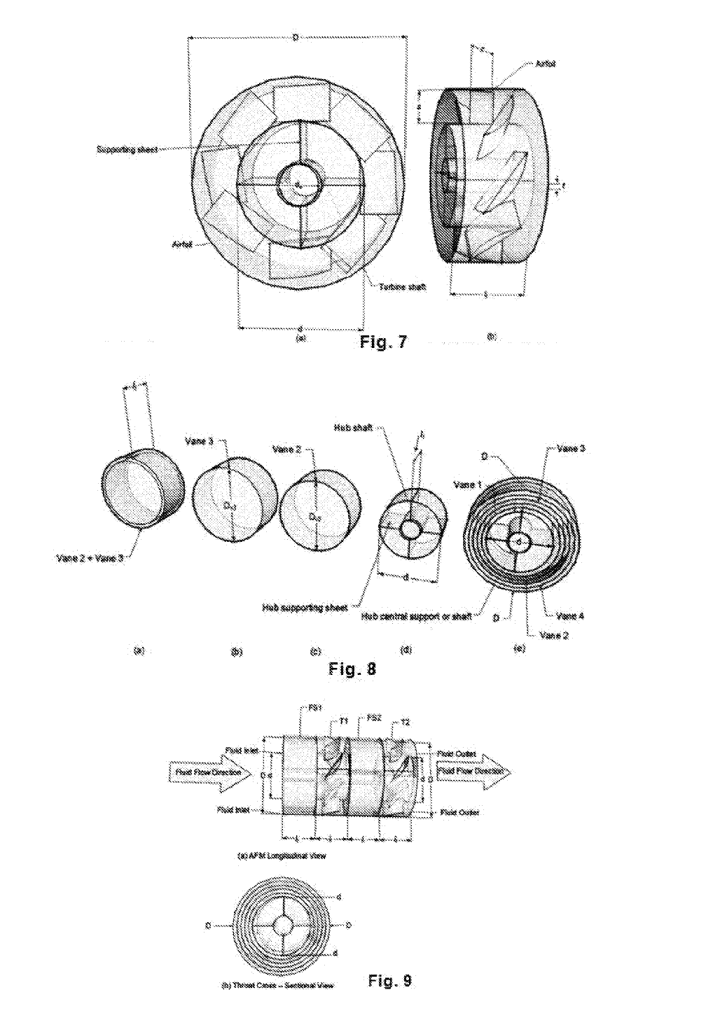

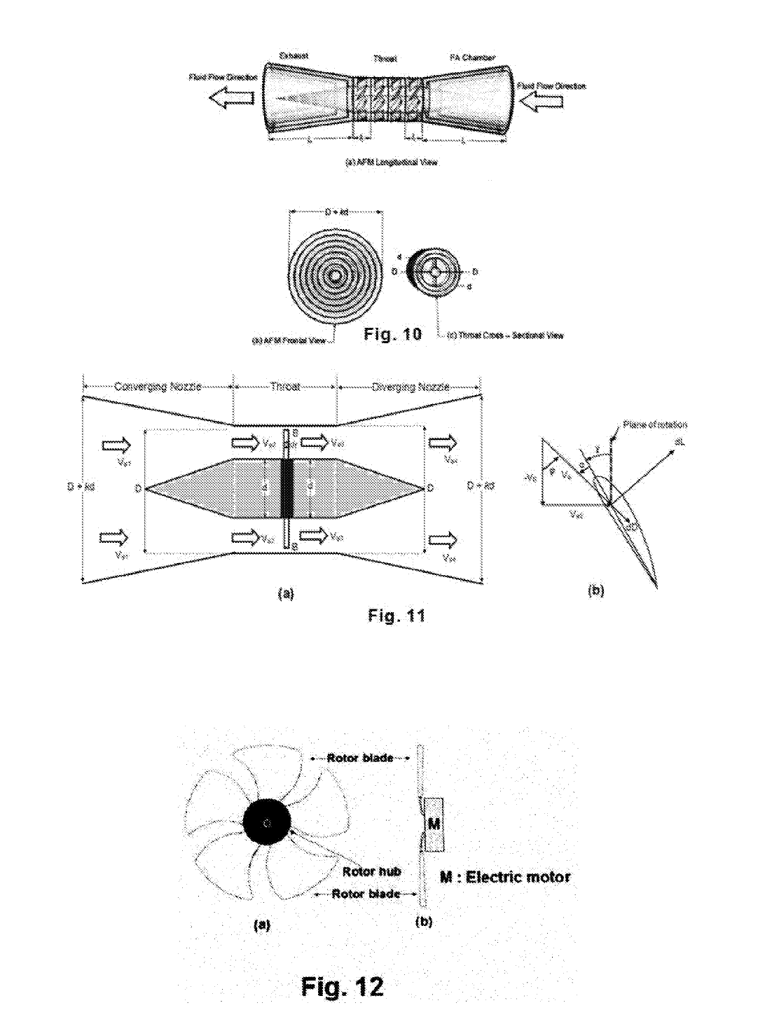

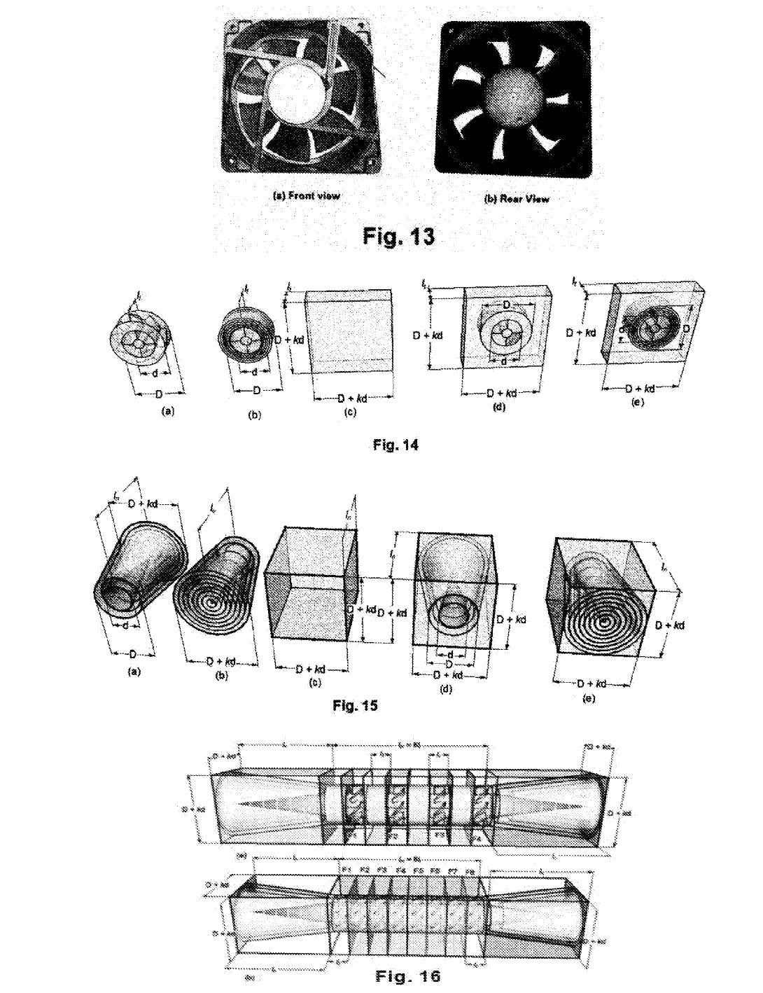

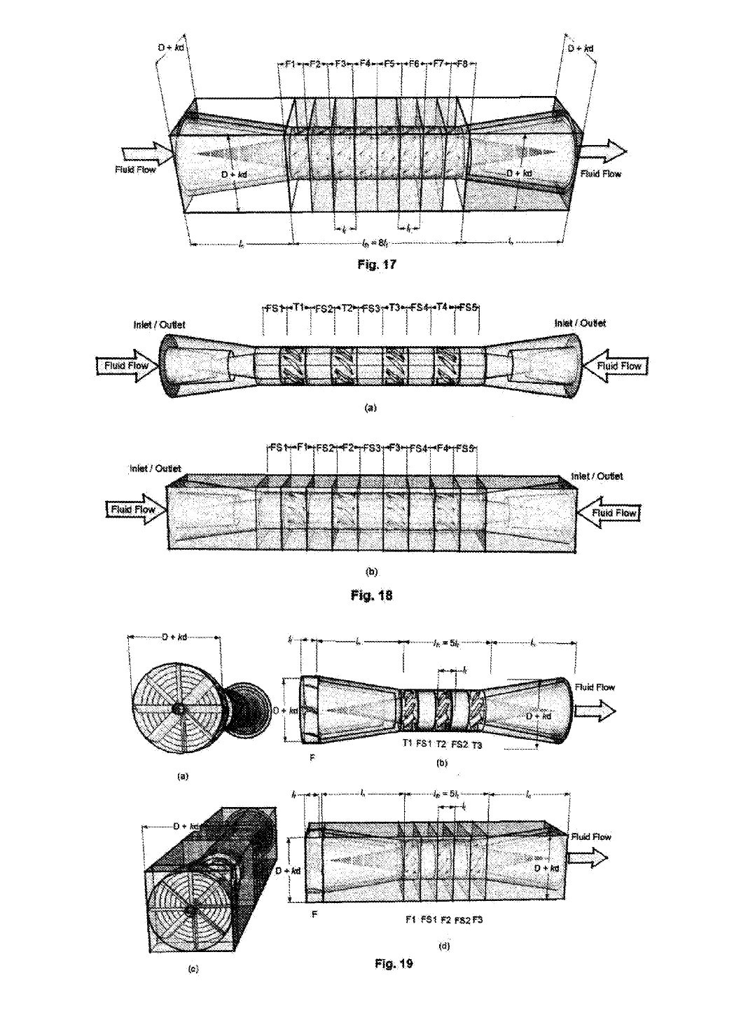

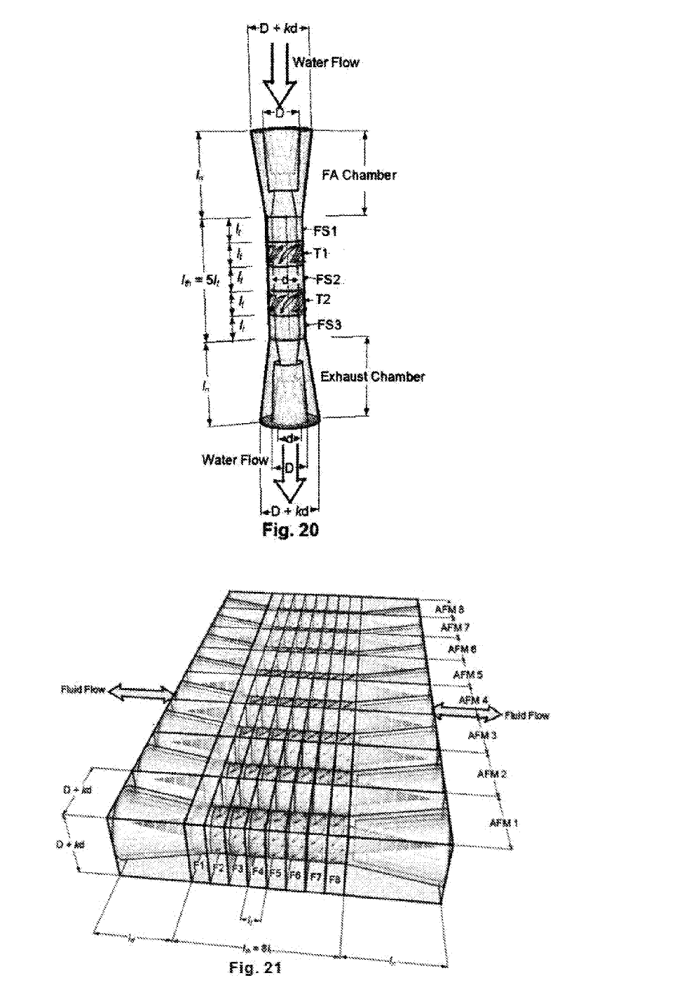

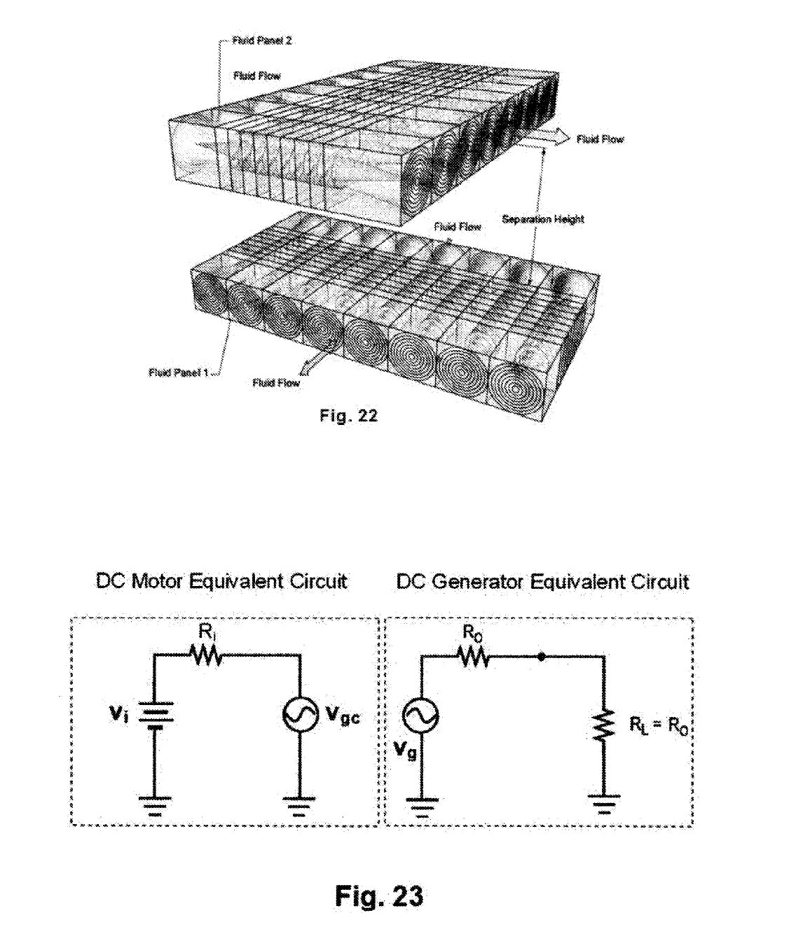

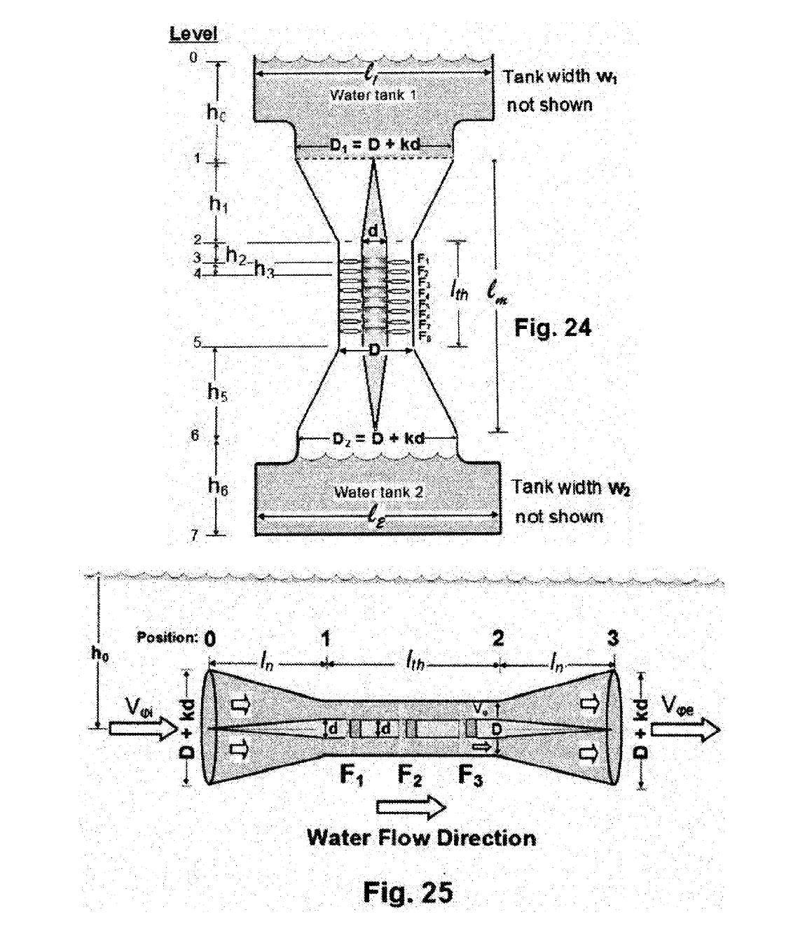

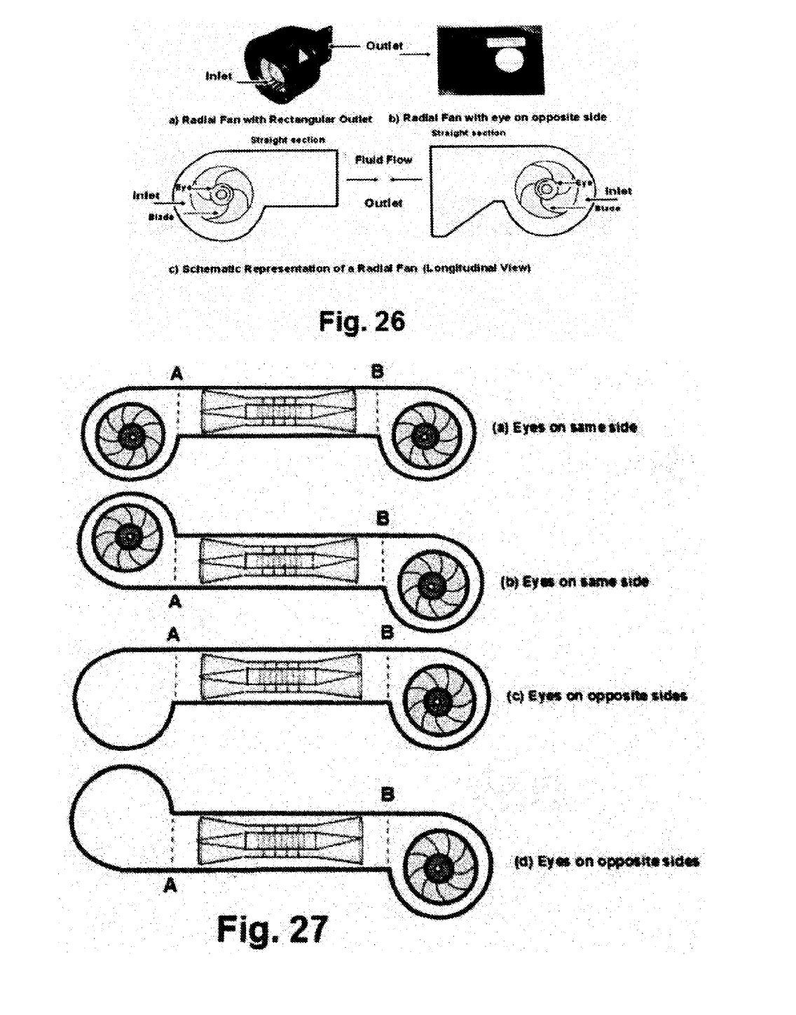

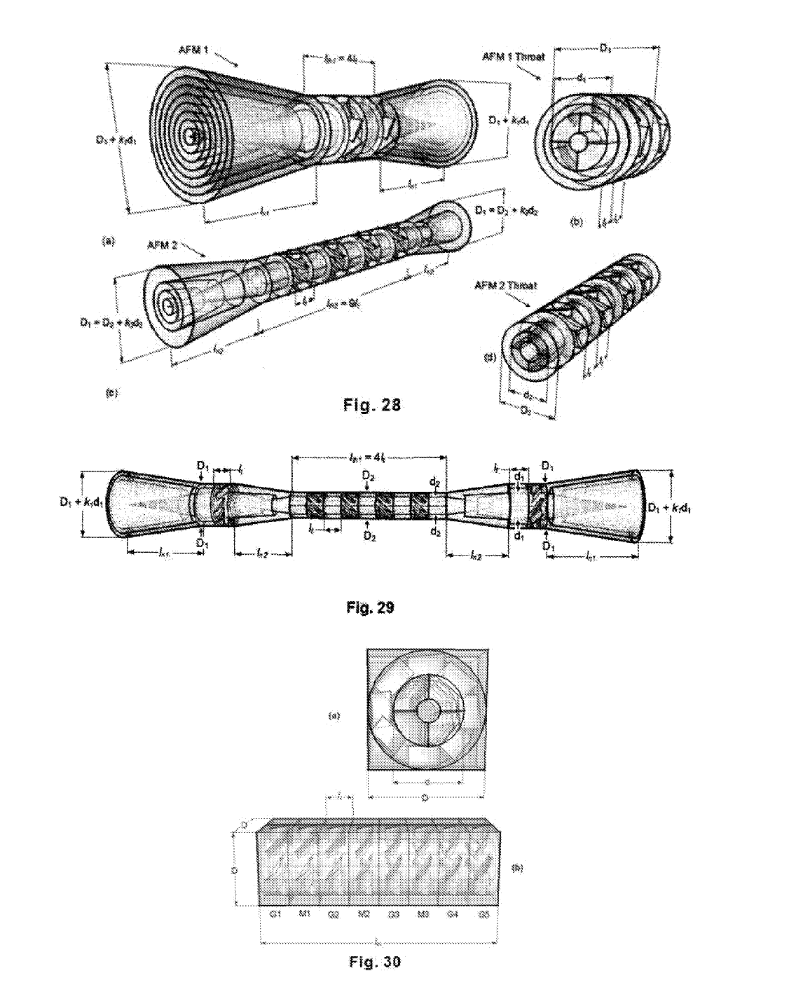

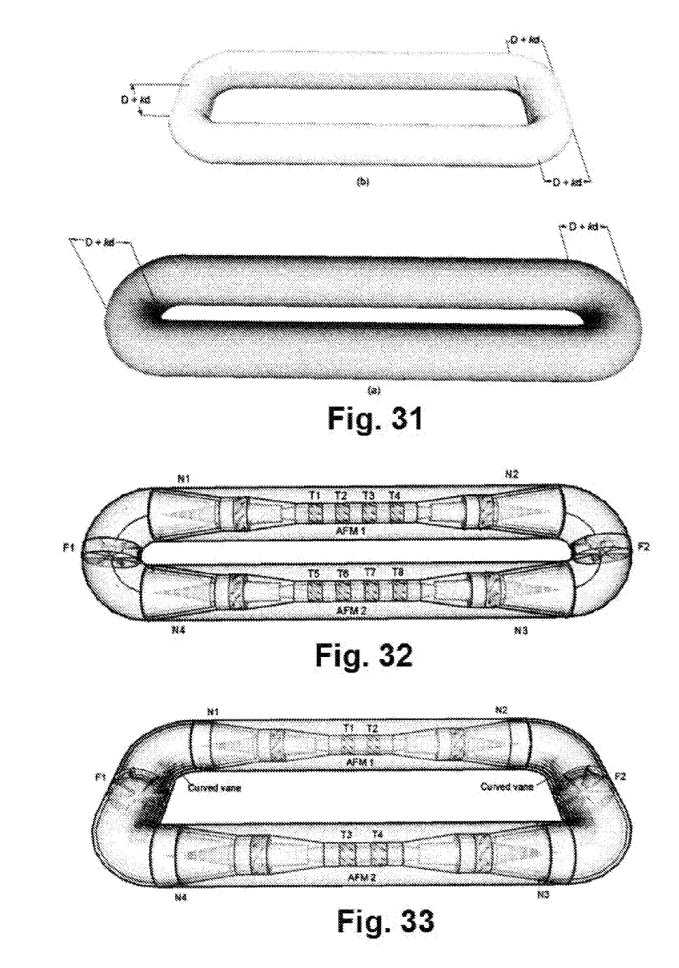

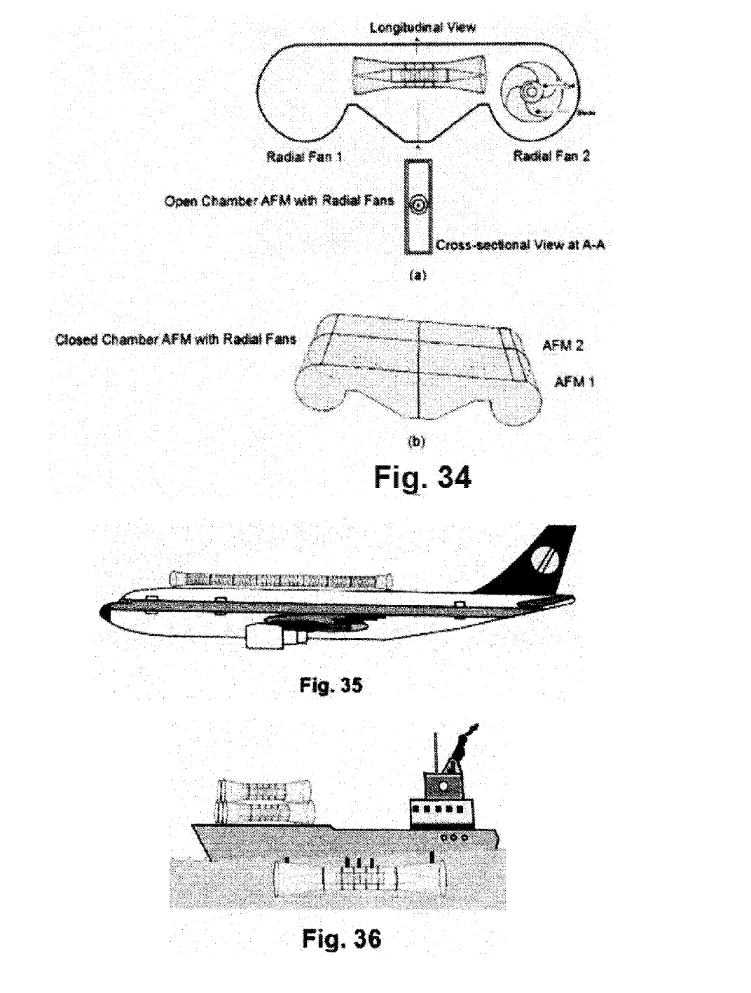

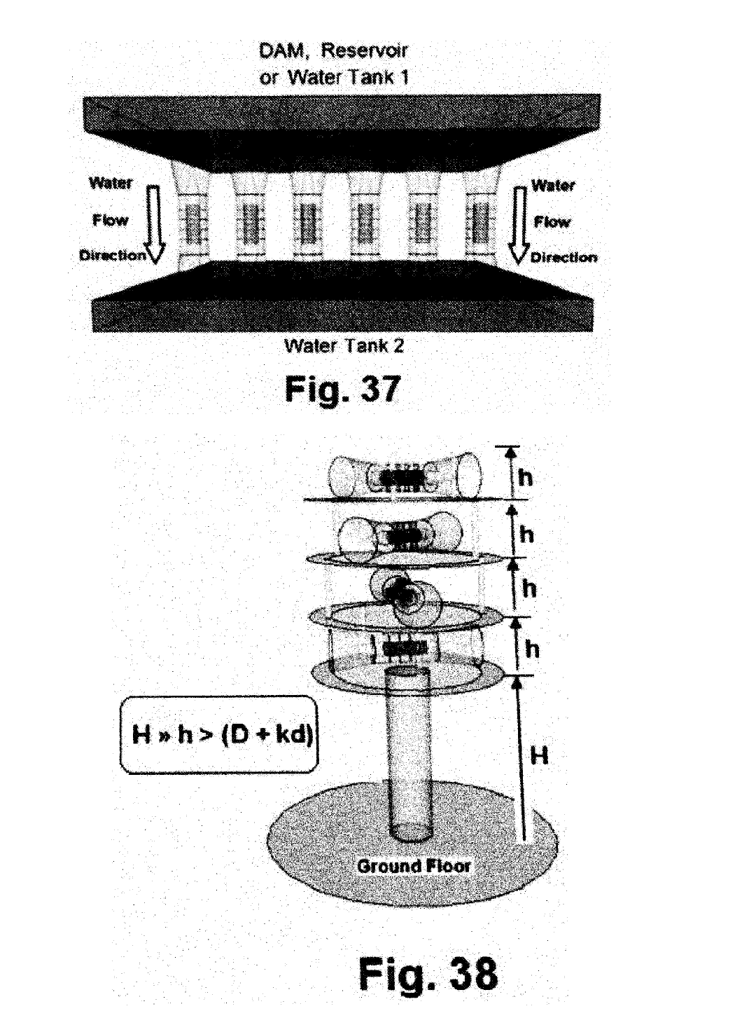

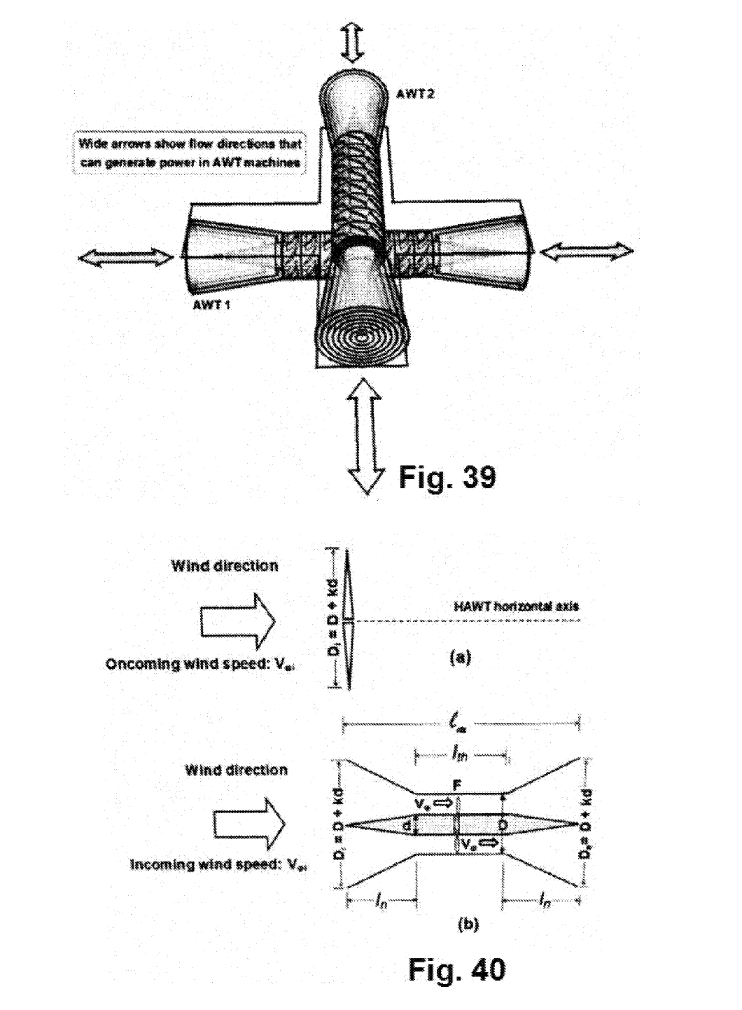

### BEST MODE FOR CARRYING OUT THE INVENTION

The main innovation presented in this document is the accelerated fluid machine and its main varieties, namely, the water electric generator, the air electric generator, and the accelerated wind turbine. Combinations of AF machines like the fluid panel and the tandem AF machines have also been proposed to achieve higher power generation. We suggest employing symmetrical AF machines and electric brushless dc axial fans with high flowrate Q to implement each of them. As to the best way to carry out the water electric generator, this has been explained already in sections A Vertical Accelerated Water Machine, Power Calculations for a Vertical AW Machine, and Realizability Conditions for the Vertical Accelerated Water Machine.

Regarding the best way to implement the air electric generator, the design process can be divided into two parts, namely, the mechanical power calculations, and the electrical power calculations. The mechanical power calculations are carried out as explained in sections Mechanical Power Calculations, Calculation of the Mechanical Power Gain for an AF Machine, and Condition for Self Sustained Movement of the Fluid Turbines. The purpose of these calculations is to determine the required number of fans, Nₜ, the number of revolutions per minute, n, for a given fluid speed V_{φ1}, the input power Pᵢ, the generated power P_{g}, and the mechanical power gain Gₚₘ to ensure a self sustainable movement, i.e. Gₚₘ>1. Once this is achieved the electric power calculations are carried out as explained in sections Electrical Power Calculations, and Self Sustainable Fluid Electric Generator, keeping in mind that the electrical power gain Gₚₑ must be greater than 1 for self sustainability; hence the total input resistance Rᵢ of the motor fan(s), the total output resistance Rₒ of the generator fan(s), applied input voltage vᵢ, and the generated voltage v_{g} must fulfill Inequality (51).

Example Let us assume an air electric generator having D=0.5 m, d=0.3 m, Nₜ=4 identical fans, each with N_{b}=8 blades; n=900 rpm, and the following blade parameters: C_{D}=0.040163; C_{L}=0.46852, span s=0.09 m; chord c=0.175 m, φ=45°, k=1, and V_{φ1}=8.25 m/s. Then, by applying Equations (8), (9), (15), (19), (32), (37) and (38), respectively, the results shown in Table III were obtained for k_{f}, nozzle length lₙ, V_{φ2}, V_{φ}, input fluid power P_{φi}, generated mechanical power P_{g}, and mechanical power gain Gₚₘ.

TABLE III
Power calculation results for an air electric generator

| | | | V_{φ1}, | | | | | |
|---|---|---|---|---|---|---|---|---|
| k | k_{f} | lₙ, m | m/s | V_{φ2}, m/s | V_{φ}, m/s | P_{φi}, W | P_{g}, W | Gₚₘ |
| 1 | 4 | 0.95 | 8.25 | 33 | 46.67 | 173.58 | 4,282.65 | 24.67 |

The best way to implement an Accelerated Wind Turbine is shown schematically in FIG. 40 (b). Let us first compare the power gain obtainable with a conventional horizontal axis wind turbine and with an Accelerated Wind Turbine. FIG. 40 shows the side views of both machines. Let us assume the maximum diameter of both machines is the same, namely Dᵢ=D+kd. In order to make the performance comparison between both machines, we will assume that the AW turbine has just one fan, and that the three blades of both machines have the same value for coefficients C_{L} and C_{D}.

The power P_{φi} of the incoming wind flow at the entrance of both machines is given by:

P_{φi}=πρ(D+kd)²V_{φ1}³/8 (87)

According to Betz's Law for conventional wind turbines, the maximum power Pᵢ a HAWT can capture from the incoming wind is 59.3%, i.e., HAWT power efficiency ≦59.3%.

From Eq. (26), it can be readily shown that for a HAWT with N_{b} blades, chord c, the useful mechanical power generated, P_{g}, is given by

P_{g}=(π/480)ρ(C_{L} sin φ−C_{D} cos φ)N_{b}c[(D+kd)²−d²)]nV_{φ1}² (88)

For our AWT, on the other hand, we use Eq. (26) to calculate P_{g}

P_{g}=(π/480)ρ(C_{L} sin φ−C_{D} cos φ)N_{b}c(D²−d²)nV_{φ}² (26)

Where V_{φ} is given by Eq. (35) as

V_{φ}=k_{f}V_{φ1}/sin φ (35)

And the mechanical power gain (Efficiency) for both machines is defined as

Gₚₘ=P_{g}/Pᵢ (38)

Equations (87), (88), (26), (35), and (38) can be used to design a HAWT and an AWT.

Example Assuming the following data to be the same for both HAWT and the AWT machines: V_{φ1}=10 m/s N_{b}=3 blades, k=2, coefficient values: C_{D}=0.040163; C_{L}=0.46852, D=0.5 m, d=0.3 m, blade chord c=0.15 m and n=900 rpm. Then, by applying previous data and Equations (8), (9), (35), (87), (88) or (26), and (38), we obtain, respectively, the results shown in Table IV for the fluid velocity multiplier k_{f}; nozzle length lₙ, relative fluid velocity in AWT throat, V_{φ}; input power P_{φi}; generated mechanical power P_{g}, and mechanical power gain Gₚₘ. Observe that the power generated by the HAWT is 110.61 W, whereas the power generated by our AW turbine is 1,807.34 W, i.e., 16 times bigger! On the other hand, for this AWT the power gain Gₚₘ exceeds 100%, which is not possible for the HAWT.

TABLE IV
Power Calculation Results for an HAWT and an AWT machine

| Ma- | | | | V_{φ1}, | | | | |
|---|---|---|---|---|---|---|---|---|
| chine | k | k_{f} | lₙ, m | m/s | V_{φ}, m/s | P_{φi}, W | P_{g}, W | Gₚₘ |
| HAWT | 2 | NA | NA | 10 | NA | 584.45 | 110.61 | 0.19 |
| AWT | 2 | 7.56 | 1.89 | 10 | 106.95 | 584.45 | 1,807.34 | 3.09 |

NA: Not applicable

1-11. (canceled)

12. A power conversion machine comprising:
a fluid accelerator,
a throat having a fluid inlet and a fluid outlet, and
a turbine disposed within the throat and rotatable therein, the blades of the turbine being of substantially airfoil-shape,
wherein the machine is configured such that fluid accelerated by the fluid accelerator is caused to pass through the throat so as to cause rotation of the turbine.

13. The power conversion machine of claim 12 wherein the fluid accelerator is a conduit having a fluid inlet and a fluid outlet, the conduit fluid outlet being in fluid communication with the throat fluid inlet.

14. The power conversion machine of claim 13 wherein the conduit is a convergent nozzle.

15. The power conversion machine of claim 12 wherein the fluid accelerator accelerates the fluid velocity by artificial means.

16. The power conversion machine of claim 15 wherein the artificial means requires energy input.

17. The power conversion means of claim 16 wherein the artificial means is a fan configured to accelerate and drive fluid toward the turbine.

18. The power generation means of claim 17 wherein the fan is rotatable within the throat, and is coaxial with the turbine.

19. The power conversion means of claim 14 wherein the artificial means is a moving object to which the machine is attached.

20. The power conversion machine of claim 12 comprising a fluid decelerator configured to decelerate fluid exiting the turbine.

21. The power conversion machine of claim 20 wherein the fluid decelerator is a conduit having a fluid inlet and a fluid outlet, the conduit fluid inlet being in fluid communication with the throat fluid outlet.

22. The power conversion machine of claim 21 wherein the conduit is a divergent nozzle.

23. The power conversion machine of claim 12 wherein the throat is a Venturi-like throat.

24. The power conversion machine of claim 12 wherein the turbine comprises an internal cylinder surrounded by and coaxial with an external cylinder, with the blades extending from the internal cylinder to the external cylinder such that the leading edges of the blades face the throat inlet.

25. The power conversion machine of claim 12 comprising two or more turbines, all turbines being coaxial.

26. The power conversion machine of claim 12 comprising a fluid flow straightener configured to straighten to flow of fluid entering the throat or exiting the throat.

27. The power conversion machine of claim 26 comprising two fluid flow straighteners, the first straightener configured to straighten to flow of fluid entering the throat, and the second straightener configured to straighten flow of fluid exiting the throat.

28. The power conversion machine of claim 26 wherein the fluid flow straightener is a vane, or a series of vanes, configured to deflect fluid flow.

29. A system for generating electrical power comprising the power conversion machine of claim 12 in combination with an electrical generator, wherein the generator is configured to harness the rotational mechanical output of the turbine.

30. A method for generating electrical power comprising the steps of:
providing the system of claim 29,
allowing or causing a fluid to enter the throat of the power conversion machine so as to cause the turbine to rotate, and
harnessing the electrical energy produced by the electrical generator.

31. The method of claim 30 wherein the fluid is a gas or a liquid.
